(19) United States
(12) Patent Application Publication
(10) Pub. No.: US 2026/0287807 A1
(43) Pub. Date: Sep. 24, 2026

(54) OPTICAL ELEMENT

(71) Applicant: FUJIFILM Corporation, Tokyo (JP)

(72) Inventors: Hiroshi SATO, Minamiashigara-shi (JP); Yukito SAITOH, Minamiashigara-shi (JP); Keisuke KODAMA, Minamiashigara-shi (JP)

(73) Assignee: FUJIFILM Corporation, Tokyo (JP)

(21) Appl. No.: 19/665,039

(22) Filed: May 1, 2026

Related U.S. Application Data
(63) Continuation of application No. PCT/JP2024/043225, filed on Dec. 6, 2024.

(30) Foreign Application Priority Data
Dec. 11, 2023 (JP) 2023-208616
Oct. 31, 2024 (JP) 2024-191765

(51) Int. Cl. G02B 5/30; G02B 27/01

(52) U.S. Cl. CPC G02B 5/3016; G02B 27/0172

(57) ABSTRACT

An object is to provide an optical element capable of diffracting incident light with high diffraction efficiency. The object is achieved by an optical element including a first optically anisotropic layer containing a rod-like liquid crystal compound and a second optically anisotropic layer containing a disk-like liquid crystal compound, in which the first optically anisotropic layer and the second optically anisotropic layer have a first liquid crystal alignment pattern in which a direction of an optical axis derived from a liquid crystal compound changes while continuously rotating along at least one direction, and have a region where the direction of the optical axis rotates by 180° at a period of shorter than 0.5 μm.

### CROSS-REFERENCE TO RELATED APPLICATIONS

This application is a Continuation of PCT International Application No. PCT/JP2024/043225 filed on Dec. 6, 2024, which claims priority under 35 U.S.C. § 119(a) to Japanese Patent Application No. 2023-208616 filed on Dec. 11, 2023 and Japanese Patent Application No. 2024-191765 filed on Oct. 31, 2024. The above applications are hereby expressly incorporated by reference, in their entirety, into the present application.

### BACKGROUND OF THE INVENTION

### 1. Field of the Invention

The present invention relates to an optical element used in a head-mounted display or the like.

### 2. Description of the Related Art

A diffraction element is used in many optical devices, optical systems, and the like as an optical element that bends light to control a traveling direction of the light.

As such an optical element, a liquid crystal diffraction element formed of a liquid crystal compound has been proposed.

For example, JP2017-522601A describes a liquid crystal diffraction element (optical element) including a plurality of laminated birefringent sublayers that are configured to change a propagation direction of light passing through an inside of the liquid crystal diffraction element according to a Bragg condition, in which the laminated birefringent sublayers include local optical axes that change along respective boundary surfaces between adjacent laminated birefringent sublayers to define respective lattice periods.

Specifically, the liquid crystal diffraction element described in JP2017-522601A has a liquid crystal alignment pattern in which an optical axis derived from a liquid crystal compound changes while continuously rotating along at least one in-plane direction.

In a case where circularly polarized light is incident into the liquid crystal diffraction element having such a liquid crystal alignment pattern, the incident light is diffracted along a direction in which the optical axis derived from the liquid crystal compound continuously rotates, depending on a revolution direction of the circularly polarized light and a rotation direction of the optical axis derived from the liquid crystal compound.

The liquid crystal diffraction element described in JP2017-522601A can be used in various optical devices and optical systems, for example, a beam steering device that bends light in a desired direction.

### SUMMARY OF THE INVENTION

In recent years, various optical devices, optical systems, and the like have been required to be miniaturized and thinned.

For example, a head-mounted display (HMD) that provides a user with virtual reality (VR), augmented reality (AR), or the like is required to be thinned.

In order to thin the HMD including the liquid crystal diffraction element, it is necessary to significantly diffract light using the liquid crystal diffraction element.

However, in the liquid crystal diffraction element in the related art, in a case where light is significantly diffracted, the diffraction efficiency is deteriorated, and a large amount of light that is not diffracted by the liquid crystal diffraction element and transmits as it is, that is, so-called zero-order light is generated.

An object of the present invention is to solve the above-described problem of the related art and to provide an optical element that can diffract incident light with high diffraction efficiency.

In order to achieve this object, the present invention has the following configurations.

[1] An optical element comprising:
a first optically anisotropic layer that is a cured layer of a liquid crystal composition containing a rod-like liquid crystal compound; and
a second optically anisotropic layer that is a cured layer of a liquid crystal composition containing a disk-like liquid crystal compound,
in which the first optically anisotropic layer has a first liquid crystal alignment pattern in which the rod-like liquid crystal compound is arranged along at least one in-plane direction and in which a direction of an optical axis derived from the rod-like liquid crystal compound changes while continuously rotating, and has, in the first liquid crystal alignment pattern, a region in which the direction of the optical axis of the rod-like liquid crystal compound rotates by 180° with a period shorter than 0.5 μm, and
the second optically anisotropic layer has a second liquid crystal alignment pattern in which the disk-like liquid crystal compound is arranged along at least one in-plane direction and in which a direction of an optical axis derived from the disk-like liquid crystal compound changes while continuously rotating, and has, in the second liquid crystal alignment pattern, a region in which the direction of the optical axis of the disk-like liquid crystal compound rotates by 180° with a period shorter than 0.5 μm.

[2] The optical element according to [1],
in which in the first optically anisotropic layer, the rod-like liquid crystal compound is twisted and aligned in a thickness direction of the first optically anisotropic layer according to a first twist property.

[3] The optical element according to [1] or [2],
in which in the second optically anisotropic layer, the disk-like liquid crystal compound is twisted and aligned in a thickness direction of the second optically anisotropic layer according to a second twist property.

[4] The optical element according to [2],
in which in the second optically anisotropic layer, the disk-like liquid crystal compound is twisted and aligned in a thickness direction of the second optically anisotropic layer according to a second twist property,
the first twist property and the second twist property are the same in direction, and
in the first optically anisotropic layer and the second optically anisotropic layer, twisted alignment of the optical axis of the rod-like liquid crystal compound and twisted alignment of the optical axis of the disk-like liquid crystal compound form continuous twisted alignment.

[5] The optical element according to [2],
in which in the second optically anisotropic layer, the disk-like liquid crystal compound is twisted and aligned in a thickness direction of the second optically anisotropic layer according to a second twist property, and
the first twist property and the second twist property are opposite in direction.

[6] The optical element according to [1],
in which in the first optically anisotropic layer, the rod-like liquid crystal compound is cholesterically aligned in a thickness direction, and
in the second optically anisotropic layer, the disk-like liquid crystal compound is cholesterically aligned in a thickness direction.

[7] The optical element according to [6],
in which the rod-like liquid crystal compound in the first optically anisotropic layer and the disk-like liquid crystal compound in the second optically anisotropic layer are continuously cholesterically aligned in a thickness direction.

[8] The optical element according to any one of [1] to [7],
in which the first optically anisotropic layer has a region in which the rod-like liquid crystal compound is tilt-aligned in a plane of the optically anisotropic layer in a thickness direction of the first optically anisotropic layer.

[9] The optical element according to any one of [1] to [8],
in which the second optically anisotropic layer has a region in which the disk-like liquid crystal compound is tilt-aligned in a plane of the optically anisotropic layer in a thickness direction of the second optically anisotropic layer.

[10] The optical element according to any one of [1] to [9],
in which an optically anisotropic layer that is the cured layer of the liquid crystal composition containing the rod-like liquid crystal compound and an optically anisotropic layer that is the cured layer of the liquid crystal composition containing the disk-like liquid crystal compound are alternately laminated.

[11] A head-mounted display comprising:
the optical element according to any one of [1] to [10].

With the optical element according to an aspect of the present invention, incident light can be diffracted with high diffraction efficiency.

### BRIEF DESCRIPTION OF THE DRAWINGS

FIG. 1 is a diagram conceptually showing an example of an optical element according to the embodiment of the present invention.

FIG. 2 is a diagram conceptually showing another example of the optical element according to the embodiment of the present invention.

FIG. 3 is a diagram conceptually showing another example of the optical element according to the embodiment of the present invention.

FIG. 4 is a front view conceptually showing a rod-like liquid crystal layer of the optical element shown in FIG. 1.

FIG. 5 is a plan view conceptually showing the rod-like liquid crystal layer of the optical element shown in FIG. 1.

FIG. 6 is a front view conceptually showing a disk-like liquid crystal layer of the optical element shown in FIG. 1.

FIG. 7 is a plan view conceptually showing the disk-like liquid crystal layer of the optical element shown in FIG. 1.

FIG. 8 is a conceptual view of an example of an exposure device that exposes an alignment film.

FIG. 9 is a conceptual diagram showing an action of the rod-like liquid crystal layer.

FIG. 10 is a conceptual diagram showing the action of the rod-like liquid crystal layer.

FIG. 11 is a plan view conceptually showing still another example of the rod-like liquid crystal layer constituting the optical element according to the embodiment of the present invention.

FIG. 12 is a conceptual diagram showing another example of the exposure device that exposes an alignment film.

FIG. 13 is a diagram conceptually showing another example of the optical element according to the embodiment of the present invention.

FIG. 14 is a conceptual diagram illustrating an action of the optical element shown in FIG. 13.

FIG. 15 is a diagram conceptually showing an example of an HMD according to the embodiment of the present invention.

FIG. 16 is a diagram conceptually showing still another example of the HMD according to the embodiment of the present invention.

FIG. 17 is a diagram conceptually showing still another example of the HMD according to the embodiment of the present invention.

FIG. 18 is a conceptual diagram showing an evaluation method of Examples according to the embodiment of the present invention.

FIG. 19 is a conceptual diagram showing an evaluation method of still another Example according to the embodiment of the present invention.

### DESCRIPTION OF THE PREFERRED EMBODIMENTS

Hereinafter, an optical element according to an embodiment of the present invention will be described in detail based on preferable embodiments shown in the accompanying drawings.

In the present specification, numerical ranges represented by “to” include numerical values before and after “to” as lower limit values and upper limit values.

In the present specification, “(meth)acrylate” represents “either or both of acrylate and methacrylate”.

In the present specification, “same”, “equal”, and the like include an error range generally accepted in the technical field. [Optical element]

Specifically, the optical element according to the embodiment of the present invention is a liquid crystal diffraction element,
the optical element comprising: a first optically anisotropic layer that is a cured layer of a liquid crystal composition containing a rod-like liquid crystal compound; and a second optically anisotropic layer that is a cured layer of a liquid crystal composition containing a disk-like liquid crystal compound,
in which the first optically anisotropic layer has a first liquid crystal alignment pattern in which the rod-like liquid crystal compound is arranged along at least one in-plane direction and in which a direction of an optical axis derived from the rod-like liquid crystal compound changes while continuously rotating, and has, in the first liquid crystal alignment pattern, a region in which the direction of the optical axis of the rod-like liquid crystal compound rotates by 180° with a period shorter than 0.5 μm, and
the second optically anisotropic layer has a second liquid crystal alignment pattern in which the disk-like liquid crystal compound is arranged along at least one in-plane direction and in which a direction of an optical axis derived from the disk-like liquid crystal compound changes while continuously rotating, and has, in the second liquid crystal alignment pattern, a region in which the direction of the optical axis of the disk-like liquid crystal compound rotates by 180° with a period shorter than 0.5 μm.

The optical element according to the embodiment of the present invention is roughly classified into two aspects of a transmission-type optical element that diffracts and transmits incident light in which the liquid crystal compound is not twisted and aligned in a thickness direction by 360° or more in the optically anisotropic layer (liquid crystal layer), and a reflective-type optical element that diffracts and reflects incident light in which the liquid crystal compound is cholesterically aligned in the thickness direction in the optically anisotropic layer.

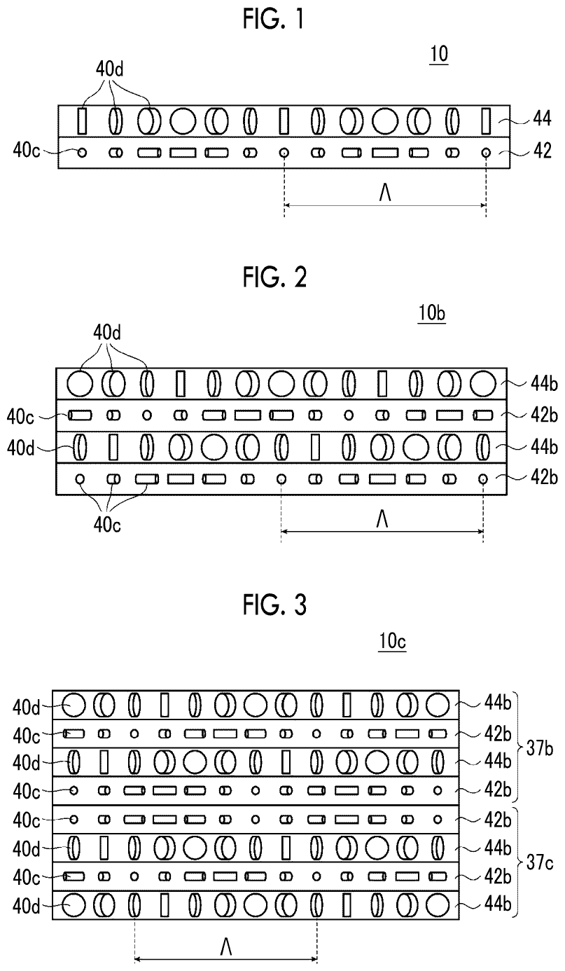

FIG. 1 conceptually shows an example of the transmission-type optical element according to the embodiment of the present invention.

All of the drawings shown below are conceptual diagrams or schematic diagrams for describing the present invention. Accordingly, a shape, a thickness, and a size of each layer shown in the drawings, a shape and a size of each member including the liquid crystal compound or the like, a positional relationship between the components, and the like do not necessarily match the actual ones.

An optical element 10 shown in FIG. 1 includes a rod-like liquid crystal layer 42 and a disk-like liquid crystal layer 44 laminated in a thickness direction.

In the optical element 10 shown in FIG. 1, the rod-like liquid crystal layer 42 is a cured layer of a liquid crystal composition including a rod-like liquid crystal compound, and is the first optically anisotropic layer in the optical element according to the embodiment of the present invention. In addition, the disk-like liquid crystal layer 44 is a cured layer of a liquid crystal composition including a disk-like liquid crystal compound, and is the second optically anisotropic layer in the optical element according to the embodiment of the present invention. Regarding this point, the same can also be applied to the rod-like liquid crystal layer and the disk-like liquid crystal layer shown below.

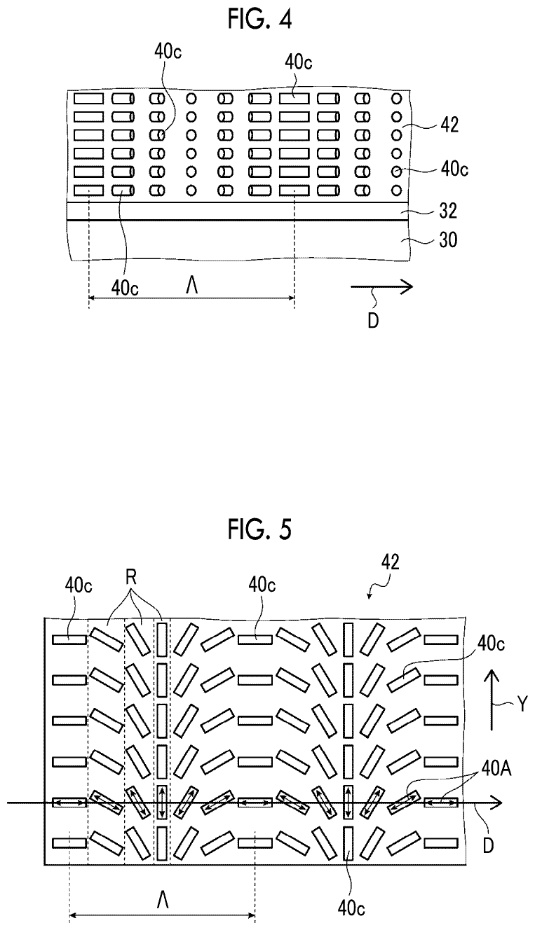

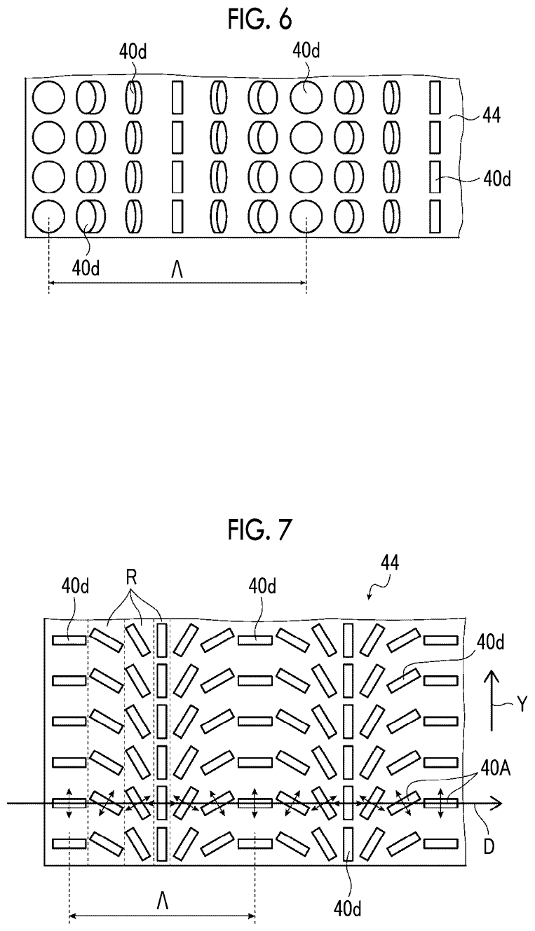

In FIG. 1, in order to simplify the drawing and to clarify the configuration of the optical element 10, the rod-like liquid crystal layer 42 and the disk-like liquid crystal layer 44 conceptually show only the liquid crystal compound (liquid crystal compound molecules) on the surface. However, as conceptually shown in FIGS. 4 and 6, each of the rod-like liquid crystal layer 42 and the disk-like liquid crystal layer 44 has a structure in which the liquid crystal compound is laminated in the thickness direction.

In the following description, in a case where it is not necessary to distinguish between the rod-like liquid crystal compound and the disk-like liquid crystal compound, both of these compounds are also collectively referred to as a liquid crystal compound.

As described above, the rod-like liquid crystal layer 42 and the disk-like liquid crystal layer 44 are laminated in the thickness direction.

The rod-like liquid crystal layer 42 is a layer in which a rod-like liquid crystal compound 40c is aligned in a liquid crystal alignment pattern in which a direction of an optical axis derived from the rod-like liquid crystal compound 40c changes while continuously rotating along at least one in-plane direction.

In addition, the disk-like liquid crystal layer 44 is a layer in which a disk-like liquid crystal compound 40d is aligned in a liquid crystal alignment pattern in which a direction of an optical axis derived from the disk-like liquid crystal compound 40d changes while continuously rotating along at least one in-plane direction.

In the following description, the “optical axis derived from the rod-like liquid crystal compound” is also simply referred to as “optical axis of the rod-like liquid crystal compound”. In addition, in the following description, the “optical axis derived from the disk-like liquid crystal compound” is also simply referred to as “optical axis of the disk-like liquid crystal compound”. Further, in the following description, the “optical axis derived from the liquid crystal compound” is also simply referred to as “optical axis”.

In addition, in the example shown in FIG. 1, the rod-like liquid crystal compound 40c and the disk-like liquid crystal compound 40d present at the same position in the plane direction of the main surface of the optical element 10 are aligned such that a longitudinal direction of the rod-like liquid crystal compound 40c and a longitudinal direction of a shape obtained by projecting the disk-like liquid crystal compound 40d to the interface of the disk-like liquid crystal layer 44 match with each other.

In the following description, the “longitudinal direction of the shape obtained by projecting the disk-like liquid crystal compound 40d to the interface of the disk-like liquid crystal layer 44” is also simply referred to as “longitudinal direction of the disk-like liquid crystal compound 40d”.

As will be described in detail later, in a case where a liquid crystal layer formed of a liquid crystal compound has a liquid crystal alignment pattern in which a direction of an optical axis changes while continuously rotating along at least one in-plane direction, transmitted light can be diffracted. That is, the liquid crystal layer (optically anisotropic layer) having such a liquid crystal alignment pattern acts as a liquid crystal diffraction element.

In this case, a diffraction angle depends on the single period Λ in a case where a length (length A) over which the direction of the optical axis derived from the liquid crystal compound rotates by 180° in a plane in the liquid crystal alignment pattern is set as the single period Λ of the liquid crystal alignment pattern. That is, in the liquid crystal diffraction element, the single period Λ over which the direction of the optical axis rotates by 180° in a plane is the single period of the periodic structure in the diffraction element. In the diffraction element, as the single period Λ decreases, the diffraction angle increases. Therefore, the diffraction angle can be adjusted by adjusting the single period of the liquid crystal alignment pattern.

In the optical element according to the embodiment of the present invention, both the rod-like liquid crystal layer 42 (first optically anisotropic layer) and the disk-like liquid crystal layer 44 (second optically anisotropic layer) have the single period Λ of less than 0.5 μm. That is, the optical element according to the embodiment of the present invention has a region where the direction of the optical axis of the liquid crystal compound rotates by 180° at a period of less than 0.5 μm. Accordingly, in the optical element according to the embodiment of the present invention, the single period Λ is extremely short, and incident light can be diffracted at a large diffraction angle.

In consideration of the accuracy of the liquid crystal alignment pattern, the difficulty in forming the liquid crystal layer, and the like, in the optical element according to the embodiment of the present invention, the single period Λ in the rod-like liquid crystal layer (first optically anisotropic layer) and the disk-like liquid crystal layer (second optically anisotropic layer) is preferably 0.05 μm or more.

In addition, the diffraction direction of light in the liquid crystal diffraction element depends on the rotation direction of the optical axis in the liquid crystal alignment pattern. Therefore, the diffraction direction can be adjusted by adjusting the rotation direction of the optical axis in the liquid crystal alignment pattern.

Here, in the example shown in the drawing, as a preferable aspect, the rotation direction of the optical axis in the liquid crystal alignment pattern of the rod-like liquid crystal layer 42 and the rotation direction of the optical axis in the liquid crystal alignment pattern of the disk-like liquid crystal layer 44 are the same as each other, and the length of the single period of the liquid crystal alignment pattern of the rod-like liquid crystal layer 42 and the length of the single period of the liquid crystal alignment pattern of the disk-like liquid crystal layer 44 are the same as each other.

Here, as described above, at least at an interface between the rod-like liquid crystal layer 42 and the disk-like liquid crystal layer 44, regarding the rod-like liquid crystal compound 40c and the disk-like liquid crystal compound 40d present at the same position in the plane direction, a longitudinal direction of the rod-like liquid crystal compound 40c and a longitudinal direction of a shape obtained by projecting the disk-like liquid crystal compound 40d to the interface of the disk-like liquid crystal layer 44 match with each other.

In the present invention, since the single periods and the rotation directions of the liquid crystal alignment patterns of the laminated rod-like liquid crystal layer 42 and disk-like liquid crystal layer 44 are the same as each other, the laminated rod-like liquid crystal layer 42 and disk-like liquid crystal layer 44 integrally exhibit an optical action as one liquid crystal layer (optically anisotropic layer) having a predetermined liquid crystal alignment pattern.

In the diffraction element formed of a liquid crystal compound, there is a problem in that, since the diffraction performance such as the diffraction efficiency has incidence angle dependence, the diffraction efficiency decreases in a case where the incidence angle of light increases. Specifically, for example, in the case of a single liquid crystal layer where the rod-like liquid crystal compound is aligned in a predetermined liquid crystal alignment pattern, in a case where the liquid crystal layer is seen from a direction perpendicular to a surface of the liquid crystal layer, a difference between the length in the longitudinal direction and the length in the lateral direction of the rod-like liquid crystal compound is the same without depending on the direction of the rod-like liquid crystal compound.

Therefore, the in-plane retardation Re is fixed irrespective of the position in the plane direction of the liquid crystal layer. On the other hand, in a case of being viewed from an oblique direction with respect to the surface of the liquid crystal layer, the difference between the length of the rod-like liquid crystal compound in the longitudinal direction and the length of the rod-like liquid crystal compound in the lateral direction varies depending on the orientation of the rod-like liquid crystal compound. Therefore, the in-plane retardation Re varies depending on the position in the plane direction of the liquid crystal layer.

Accordingly, in a case where light is incident into the surface of the liquid crystal layer from an oblique direction, the optical action of the liquid crystal layer is different from that in a case where light is incident into the surface of the liquid crystal layer from a direction perpendicular to the surface of the liquid crystal layer, and the diffraction efficiency decreases. Regarding this point, the same applies to a single liquid crystal layer in which a disk-like liquid crystal compound is aligned in a predetermined liquid crystal alignment pattern.

This way, the in-plane retardation Re changes depending on the incidence angle of light in a case where the thickness direction retardation Rth of the liquid crystal layer is not zero.

In addition, as will be described in detail later, the transmission-type liquid crystal diffraction element converts incident circularly polarized light into circularly polarized light having an opposite revolution direction. Here, in a case where the thickness direction retardation Rth of the liquid crystal diffraction element is not zero, as light propagates while changing a direction in the liquid crystal diffraction element, the in-plane retardation Re on the light changes. Therefore, circularly polarized light that is diffracted by the liquid crystal diffraction element is not complete circularly polarized light. This phenomenon causes noise and is inconvenient in applications where it is not desired to mix dextrorotatory circularly polarized light and levorotatory circularly polarized light.

On the other hand, the transmissive liquid crystal diffraction element according to the embodiment of the present invention has the configuration in which the rod-like liquid crystal layer 42 and the disk-like liquid crystal layer 44 having the same single period and the rotation direction of the liquid crystal alignment pattern are alternately laminated.

Here, the rod-like liquid crystal compound 40c has positive birefringence, and the disk-like liquid crystal compound 40d has negative birefringence. Therefore, by laminating the rod-like liquid crystal layer 42 and the disk-like liquid crystal layer 44, the thickness direction retardation Rth of one liquid crystal layer in which the rod-like liquid crystal layer 42 and the disk-like liquid crystal layer 44 are alternately laminated can be brought close to zero.

As a result, the change in the in-plane retardation Re depending on the incidence angle of light can be suppressed. Therefore, the change in the in-plane retardation Re depending on the incidence angle in a case where light is incident into the optical element including the liquid crystal layer from an oblique direction is small. Therefore, the incidence angle dependence of the diffraction efficiency can be improved, and the diffraction efficiency can be improved.

In addition, in the optical element according to the embodiment of the present invention, the thickness direction retardation Rth can be brought close to zero by laminating the rod-like liquid crystal layer 42 and the disk-like liquid crystal layer 44. Therefore, even in a case where light travels in the liquid crystal diffraction element while changing the traveling direction, the influence of the retardation received by light is small. Therefore, the circularly polarized light diffracted by the optical element is converted into perfect circularly polarized light. Accordingly, the optical element according to the embodiment of the present invention can be preferably used even in applications where it is not desired to mix dextrorotatory circularly polarized light and levorotatory circularly polarized light.

The reason why the above-described diffraction efficiency can be improved is basically the same as that of the reflective optical element according to the embodiment of the present invention, that is, the reflective liquid crystal diffraction element, in which the liquid crystal compound is cholesterically aligned in the thickness direction in the rod-like liquid crystal layer and the disk-like liquid crystal layer described below.

Here, regarding the thickness of the rod-like liquid crystal layer 42 and the thickness of the disk-like liquid crystal layer 44, it is preferable that the total thickness of the rod-like liquid crystal layer 42 and the disk-like liquid crystal layer 44 is not excessively large with respect to the wavelength of light to be incident. In a case where the thickness of the rod-like liquid crystal layer 42 and the thickness of disk-like liquid crystal layer 44 are sufficiently large with respect to the wavelength of light to be incident, each of the layers exhibits an optical action (retardation) on light as a single layer. In this case, as in the case of the above-described single layer, the retardation changes depending on the incidence angle of light. Therefore, in a case where the incidence angle is large, the diffraction efficiency decreases.

From the above-described viewpoint, each of the thickness of the rod-like liquid crystal layer 42 and the thickness of the disk-like liquid crystal layer 44 may be appropriately adjusted depending on the wavelength of light to be diffracted. In a case where the light to be diffracted is visible light, the thickness is preferably 2.0 μm or less, more preferably 0.9 μm or less, still more preferably 0.7 to 0.01 μm, and even still more preferably 0.5 to 0.01 μm.

Here, in the example shown in FIG. 1, the rod-like liquid crystal layer 42 and the disk-like liquid crystal layer 44 are provided in one layer each. However, the present invention is not limited thereto.

For example, the rod-like liquid crystal layer 42 and the disk-like liquid crystal layer 44 may be provided in a four-layer configuration in which two layers are alternately provided, or may be provided in a six-layer or more configuration in which three or more layers are alternately provided.

Alternatively, a configuration in which a total of three layers are provided, such as a configuration in which the disk-like liquid crystal layer 44 is sandwiched between two rod-like liquid crystal layers 42 or a configuration in which the rod-like liquid crystal layer 42 is sandwiched between two disk-like liquid crystal layers 44, may be adopted. In addition, in a case where the rod-like liquid crystal layer 42 and the disk-like liquid crystal layer 44 are alternately laminated, a configuration in which a total of five or more layers of the rod-like liquid crystal layer 42 and the disk-like liquid crystal layer 44 are provided may be adopted. That is, the present invention is not limited to a configuration in which the rod-like liquid crystal layer 42 and the disk-like liquid crystal layer 44 have the same number of layers, and one of the rod-like liquid crystal layer 42 or the disk-like liquid crystal layer 44 may have one more layer.

The thickness of the rod-like liquid crystal layer and the thickness of the disk-like liquid crystal layer, and the total thickness of the rod-like liquid crystal layers and the total thickness of the disk-like liquid crystal layers may be the same as or different from each other.

Here, in the example shown in FIG. 1, the rod-like liquid crystal compound 40c and the disk-like liquid crystal compound 40d present at the same position in the plane direction are aligned such that the longitudinal direction of the rod-like liquid crystal compound 40c and the longitudinal direction of the disk-like liquid crystal compound 40d match each other.

However, the transmissive optical element according to the embodiment of the present invention is not limited thereto.

FIG. 2 shows another example of the optical element according to the embodiment of the present invention.

An optical element 10b shown in FIG. 2 includes a total of four layers of a rod-like liquid crystal layer 42b and a disk-like liquid crystal layer 44b that are alternately laminated in the thickness direction.

In FIG. 2, in order to simplify the drawing and clearly show the configuration of the optical element 10b, only the liquid crystal compounds on the surfaces of the rod-like liquid crystal layer 42b and the disk-like liquid crystal layer 44b are conceptually shown. However, the rod-like liquid crystal layer 42b and the disk-like liquid crystal layer 44b have a structure in which the liquid crystal compound is laminated in the thickness direction.

The rod-like liquid crystal layer 42b is a layer in which the rod-like liquid crystal compound 40c is aligned in a liquid crystal alignment pattern in which the orientation of the optical axis changes while continuously rotating along at least one in-plane direction. In addition, the disk-like liquid crystal layer 44b is a layer in which the disk-like liquid crystal compound 40d is aligned in a liquid crystal alignment pattern in which the orientation of the optical axis changes while continuously rotating along at least one in-plane direction.

In addition, a rotation direction of the optical axis in the liquid crystal alignment pattern of the rod-like liquid crystal layer 42b and a rotation direction of the optical axis in the liquid crystal alignment pattern of the disk-like liquid crystal layer 44b are the same, and the length of a single period of the liquid crystal alignment pattern of the rod-like liquid crystal layer 42b and the length of a single period of the liquid crystal alignment pattern of the disk-like liquid crystal layer 44b are the same. Further, at the interface between the rod-like liquid crystal layer 42b and the disk-like liquid crystal layer 44b, the rod-like liquid crystal compound 40c and the disk-like liquid crystal compound 40d present at the same position in the plane direction match the longitudinal direction of the rod-like liquid crystal compound 40c with the longitudinal direction of the shape obtained by projecting the disk-like liquid crystal compound 40d onto the interface of the disk-like liquid crystal layer 44b.

Here, in the example shown in FIG. 2, the longitudinal directions of the liquid crystal compounds in a plane are integrally twisted and aligned in the thickness direction from the rod-like liquid crystal layer 42b on the lower side in the drawing to the disk-like liquid crystal layer 44b on the upper side in the drawing. As a result, the two rod-like liquid crystal layers 42b and the two disk-like liquid crystal layers 44b as one liquid crystal layer have a configuration where the liquid crystal compounds are twisted and aligned in the thickness direction.

In the example shown in FIG. 2, the twisted direction of the liquid crystal compound in the optical element 10b is a direction in which the direction rotates counterclockwise from the upper side to the lower side in the drawing. In the twisted alignment of the liquid crystal compound in the optical element 10b, the twisted angle in the thickness direction is less than 360°. That is, both liquid crystal layers are twisted and aligned to such an extent that the liquid crystal layers are not cholesterically aligned.

As described above, in a case where the optical element 10b has a structure in which the liquid crystal compound is twisted and aligned in the thickness direction, the diffraction efficiency in a case where the incidence angle and the emission angle of light with respect to the optical element 10b are different from each other can be increased.

Specifically, in a cross-section parallel to the direction (arrangement axis D direction described below) in which the direction of the optical axis changes while continuously rotating, it is preferable that an angle of an incidence direction of light and an angle of an emission direction of light with respect to a Iine segment obtained by connecting the liquid crystal compounds facing the same direction to each other in the thickness direction are the same.

In addition, a configuration may be adopted in which two optically anisotropic layers shown in FIG. 2 where the rod-like liquid crystal layer and the disk-like liquid crystal layer are laminated and the longitudinal directions of the liquid crystal compounds are twisted and aligned and twisted directions of the two optically anisotropic layers are opposite to each other.

This configuration in which the liquid crystal compound is twisted and aligned in the thickness direction can also be used for the optical element having a two-layer configuration shown in FIG. 1.

FIG. 3 is a diagram conceptually showing an example of the optical element according to the embodiment of the present invention.

An optical element 10c shown in FIG. 3 includes a first laminate 37b having a total of four layers of a rod-like liquid crystal layer 42b and a disk-like liquid crystal layer 44b alternately laminated, and a second laminate 37c having a total of four layers of a rod-like liquid crystal layer 42b and a disk-like liquid crystal layer 44b alternately laminated.

The rod-like liquid crystal layer 42b is a layer in which the rod-like liquid crystal compound 40c is aligned in a liquid crystal alignment pattern in which the orientation of the optical axis changes while continuously rotating along at least one in-plane direction. In addition, the disk-like liquid crystal layer 44b is a layer in which the disk-like liquid crystal compound 40d is aligned in a liquid crystal alignment pattern in which the orientation of the optical axis changes while continuously rotating along at least one in-plane direction. In addition, a rotation direction of the optical axis in the liquid crystal alignment pattern of the rod-like liquid crystal layer 42b and a rotation direction of the optical axis in the liquid crystal alignment pattern of the disk-like liquid crystal layer 44b are the same, and the length of a single period of the liquid crystal alignment pattern of the rod-like liquid crystal layer 42b and the length of a single period of the liquid crystal alignment pattern of the disk-like liquid crystal layer 44b are the same.

That is, the rotation direction and the length of the single period of the optical axis in the liquid crystal alignment pattern of the rod-like liquid crystal layer 42b and the disk-like liquid crystal layer 44b of the first laminate 37b are the same as the rotation direction and the length of the single period of the optical axis in the liquid crystal alignment pattern of the rod-like liquid crystal layer 42b and the disk-like liquid crystal layer 44b of the second laminate 37c.

Here, in the example shown in FIG. 3, in the first laminate 37b, the longitudinal direction of the liquid crystal compound in the layer is integrally twisted and aligned in the thickness direction from the rod-like liquid crystal layer 42b on the lower side in the drawing toward the disk-like liquid crystal layer 44b on the upper side in the drawing. Specifically, the twisted direction of the liquid crystal compound in the first laminate 37b is a direction in which the liquid crystal compound is twisted counterclockwise from the upper side to the lower side in the drawing. The lower side of the first laminate 37b in the drawing is a side in contact with the second laminate 37c.

On the other hand, in the second laminate 37c, the longitudinal direction of the liquid crystal compound in the layer is integrally twisted and aligned in the thickness direction from the disk-like liquid crystal layer 44b on the lower side in the drawing toward the rod-like liquid crystal layer 42b on the upper side in the drawing. Specifically, the twisted direction of the liquid crystal compound in the second laminate 37c is a direction in which the liquid crystal compound is twisted clockwise from the upper side to the lower side in the drawing. The upper side of the second laminate 37c in the drawing is a side in contact with the first laminate 37b.

That is, the twisted direction of the liquid crystal compound in the first laminate 37b and the twisted direction of the liquid crystal compound in the second laminate 37c are opposite to each other.

As described above, by adopting the configuration in which the optical element 10c includes the laminates (optically anisotropic layers) having different twisted directions of the liquid crystal compound in the thickness direction, the angle dependence and the wavelength dependence of the diffraction efficiency are further improved.

In this case, the optimum values of the twisted angle (the total twisted angle in the thickness direction) and the retardation Δn×d of each of the optically anisotropic layers change depending on the difference Δn in refractive index of the liquid crystal compound. Therefore, the twisted angle may be optimized for each of the optically anisotropic layers. The twist angle is preferably 30° to 180°. The twisted alignment in the thickness direction can be realized by adding a typically used chiral agent.

In addition, in a case where Δn of the liquid crystal compound is large, the angle dependence and the wavelength dependence are further improved, which is preferable.

In addition, in the example shown in FIG. 3, the optical element 10c has a two-layer configuration in which the laminates having different twisted directions are laminated, but the present invention is not limited to this. The optical element may include three or more laminates having different twisted directions. Alternatively, the optical element may include a laminate in which the liquid crystal compound is not twisted in the thickness direction between the two laminates having different twisted directions. As a result, the angle dependence and the wavelength dependence of the diffraction efficiency are further improved.

In the laminate having non-twisted alignment between the laminates having twisted alignment, it is preferable that a direction of an optical axis of the liquid crystal compound is continuously connected to (facing the same direction as) a direction of an optical axis of the liquid crystal compound at an interface between the adjacent laminates having twisted alignment at each of in-plane positions. This configuration in which the directions of the optical axes of the liquid crystal compounds are continuously connected between the adjacent laminates can be prepared by laminating the liquid crystal layer of the upper layer on the liquid crystal layer of the lower layer.

In a case where the optical element has a configuration including the optically anisotropic layers having different twisted directions of the liquid crystal compounds in the thickness direction, the twisted angles per unit length in the thickness direction of the optically anisotropic layers may be the same as or different from each other.

Hereinafter, the rod-like liquid crystal layer 42 will be described using FIGS. 4 and 5.

As described above, the rod-like liquid crystal layer 42 is a rod-like liquid crystal layer that is formed by immobilizing a liquid crystal phase in which a rod-like liquid crystal compound is aligned and has a liquid crystal alignment pattern in which the direction of the optical axis derived from the liquid crystal compound changes while continuously rotating along at least one in-plane direction.

In the example shown in FIG. 4, the rod-like liquid crystal layer 42 is laminated on an alignment film 32 that is laminated on a support 30.

In the rod-like liquid crystal layer 42 of the optical element 10 shown in FIG. 1, the rod-like liquid crystal layer 42 may be in a state of being laminated on the support 30 and the alignment film 32. Alternatively, the rod-like liquid crystal layer 42 may be laminated, for example, in a state where only the alignment film 32 and the rod-like liquid crystal layer 42 are laminated after peeling off the support 30. Alternatively, the rod-like liquid crystal layer 42 may be laminated, for example, in a state where only the rod-like liquid crystal layer 42 is laminated after peeling off the support 30 and the alignment film 32.

In addition, in a case where a plurality of rod-like liquid crystal layers 42 and a plurality of disk-like liquid crystal layers 44 are alternately provided, the rod-like liquid crystal layer 42 laminated on the disk-like liquid crystal layer 44 may be directly formed and laminated on the disk-like liquid crystal layer 44, or may be formed on the support and then laminated on the disk-like liquid crystal layer 44 by peeling off the support and the alignment film as in the example of FIG. 4.

### <Support>

The support 30 supports the alignment film 32 and the rod-like liquid crystal layer 42.

As the support 30, various sheet-shaped materials (films or plate-shaped materials) can be used as long as they can support the alignment film 32 and the rod-like liquid crystal layer 42.

The transmittance of the support 30 with respect to the light to be diffracted is preferably 50% or more, more preferably 70% or more, and still more preferably 85% or more.

A thickness of the support 30 is not particularly limited, and may be appropriately set depending on the use of the optical element, a material for forming the support 30, and the like as long as the alignment film 32 and the rod-like liquid crystal layer 42 can be held.

The thickness of the support 30 is preferably 1 to 1,000 μm, more preferably 3 to 250 μm, and still more preferably 5 to 150 μm.

The support 30 may have a single layer structure or a multi-layer structure.

In a case where the support 30 has a monolayer structure, examples thereof include supports formed of glass, triacetyl cellulose (TAC), polyethylene terephthalate (PET), polycarbonates, polyvinyl chloride, acryl, polyolefin, and the like. In a case where the support 30 has a multi-layer structure, examples thereof include a support including, as a substrate, any one of the above-described supports having a single layer structure and including another layer that is provided on a surface of this substrate.

### <Alignment Film>

The alignment film 32 is formed on the surface of the support 30.

The alignment film 32 is an alignment film for aligning the rod-like liquid crystal compound 40c in a predetermined liquid crystal alignment pattern during the formation of the rod-like liquid crystal layer 42.

Although described below, in the present invention, the rod-like liquid crystal layer 42 has a liquid crystal alignment pattern in which a direction of an optical axis 40A (refer to FIG. 5) derived from the rod-like liquid crystal compound 40c changes while continuously rotating along one in-plane direction. Accordingly, the alignment film 32 is formed such that the rod-like liquid crystal layer 42 can form the liquid crystal alignment pattern.

In the following description, “the orientation of the optical axis 40A rotates” will also be simply referred to as “the optical axis 40A rotates”.

As the alignment film 32, various known films can be used.

Examples of the alignment film include a rubbing treatment film consisting of an organic compound such as a polymer, an oblique vapor-deposited film of an inorganic compound, a film having a microgroove, and a film obtained by accumulating a Langmuir-Blodgett (LB) film of an organic compound such as @-tricosanoic acid, methyldioctadecylammonium chloride, and methyl stearate using the Langmuir-Blodgett method.

The alignment film 32 formed by a rubbing treatment can be formed by rubbing a surface of a polymer layer with paper or fabric in a given direction multiple times.

The material to be used in the alignment film 32 is preferably polyimide, polyvinyl alcohol, a polymer having a polymerizable group described in JP1997-152509A (JP-H9-152509A), or a material for forming the alignment film 32 or the like, such a material as described in JP2005-97377A, JP2005-99228A, or JP2005-128503A.

The alignment film 32 can be suitably used as a so-called photo-alignment film obtained by irradiating a photo-alignment material with polarized light or non-polarized light. That is, a photo-alignment film that is formed by applying a photo-alignment material to the support 30 is suitably used as the alignment film 32.

The irradiation of polarized light can be performed in a direction orthogonal or oblique to the photo-alignment film, and the irradiation of non-polarized light can be performed in an oblique direction with respect to the photo-alignment film.

Preferable examples of the photo-alignment material used in the alignment film that can be used in the present invention include: an azo compound described in JP2006-285197A, JP2007-76839A, JP2007-138138A, JP2007-94071A, JP2007-121721A, JP2007-140465A, JP2007-156439A, JP2007-133184A, JP2009-109831A, JP3883848B, and JP4151746B; an aromatic ester compound described in JP2002-229039A; a maleimide- and/or alkenyl-substituted nadiimide compound having a photo-alignable unit described in JP2002-265541A and JP2002-317013A; a photocrosslinking silane derivative described in JP4205195B and JP4205198B, a photocrosslinking polyimide, a photocrosslinking polyamide, or a photocrosslinking polyester described in JP2003-520878A, JP2004-529220A, and JP4162850B; and a photodimerizable compound, in particular, a cinnamate compound, a chalcone compound, or a coumarin compound described in JP1997-118717A (JP-H9-118717A), JP1998-506420A (JP-H10-506420A), JP2003-505561A, WO2010/150748A, JP2013-177561A, and JP2014-012823A.

Among these, an azo compound, a photo-crosslinkable polyimide, a photo-crosslinkable polyamide, a photo-crosslinkable polyester, a cinnamate compound, or a chalcone compound is suitably used.

The thickness of the alignment film 32 is not particularly limited. The thickness with which a required alignment function can be obtained may be appropriately set depending on the material for forming the alignment film 32.

The thickness of the alignment film 32 is preferably 0.01 to 5 μm and more preferably 0.05 to 2 μm.

A method of forming the alignment film 32 is not limited. Any one of various known methods depending on the material for forming the alignment film 32 can be used. For example, a method including: applying the alignment film 32 to a surface of the support 30; drying the applied alignment film 32; and exposing the alignment film 32 to laser light to form an alignment pattern can be used.

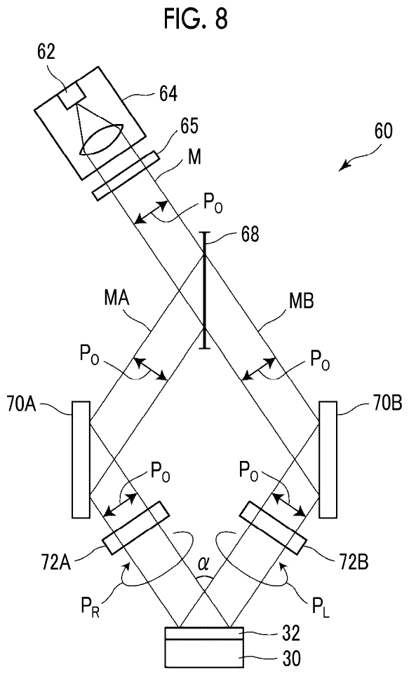

FIG. 8 conceptually shows an example of an exposure device that exposes the alignment film 32 to form an alignment pattern.

An exposure device 60 shown in FIG. 8 includes: a light source 64 comprising a laser 62; an λ/2 plate 65 that changes a polarization direction of laser light M emitted from the laser 62; a polarization beam splitter 68 that splits the laser light M emitted from the laser 62 into two beams MA and MB; mirrors 70A and 70B that are disposed on each of optical paths of the two split beams MA and MB; and λ/4 plates 72A and 72B.

The light source 64 emits linearly polarized light P₀. The λ/4 plate 72A converts the linearly polarized light P₀ (ray MA) into dextrorotatory circularly polarized light P_{R}, and the λ/4 plate 72B converts the linearly polarized light P₀ (ray MB) into levorotatory circularly polarized light P_{L}, respectively.

The support 30 including the alignment film 32 on which the alignment pattern is not yet formed is disposed in an exposed portion, the two beams MA and MB intersect and interfere with each other on the alignment film 32, and the alignment film 32 is irradiated with and exposed to the interference light.

Due to the interference in this case, the polarization state of light with which the alignment film 32 is irradiated periodically changes according to interference fringes. Accordingly, the alignment film having the alignment pattern in which the alignment states periodically change is obtained. In the following description, the alignment film having an alignment pattern will also be referred to as a “pattern alignment film”.

In the exposure device 60, the period of the alignment pattern can be adjusted by changing an intersecting angle α between the two rays MA and MB. That is, in the exposure device 60, by adjusting the intersecting angle α, in the liquid crystal alignment pattern in which the optical axis 40A changes while continuously rotating in the one direction, the length of the single period Λ over which the optical axis 40A rotates by 180° along the one direction in which the optical axis 40A rotates can be adjusted.

By forming the optically anisotropic layer on the alignment film 32 having the alignment pattern in which the alignment state periodically changes, as described below, the rod-like liquid crystal layer 42 having the liquid crystal alignment pattern in which the optical axis 40A derived from the rod-like liquid crystal compound 40c changes while continuously rotating along the one direction can be formed.

In addition, by rotating the optical axes of the λ/4 plates 72A and 72B by 90°, respectively, a rotation direction of the optical axis 40A can be reversed.

As described above, the patterned alignment film has the alignment pattern for aligning the liquid crystal compound to have the liquid crystal alignment pattern in which the direction of the optical axis of the liquid crystal compound in the rod-like liquid crystal layer formed on the patterned alignment film changes while continuously rotating along at least one in-plane direction. Assuming that the axis along the orientation in which the liquid crystal compound is aligned is an arrangement axis, it can be said that the patterned alignment film has an alignment pattern in which the orientation of the arrangement axis changes while continuously rotating over at least one in-plane direction. The arrangement axis of the patterned alignment film can be detected by measuring absorption anisotropy. For example, in a case where the pattern alignment film is irradiated with linearly polarized light while rotating the pattern alignment film and the amount of light transmitted through the pattern alignment film is measured, the orientation in which the amount of light is maximum or minimum is observed by gradually changing along one direction in the plane.

As one aspect of the present invention, a plurality of alignment patterns may be formed on the same alignment film. The plurality of alignment patterns may have an alignment pattern in which the alignment state periodically changes, and the directions of the optical axes 40A of the alignment patterns may be different from each other. In order to realize such an alignment pattern, a method of rotating the substrate with respect to the exposure device 60 and performing exposure a plurality of times, a method of providing an optical path in which the laser light M is divided into two rays MC and MD in addition to the two rays MA and MB, and switching each optical path to perform exposure a plurality of times, and the like are exemplified.

In the present invention, the alignment film 32 is provided as a preferred aspect and is not an essential component.

For example, the following configuration can also be adopted, in which, by forming the alignment pattern on the support 30 using a method of rubbing the support 30, a method of processing the support 30 with laser light or the like, or the like, the rod-like liquid crystal layer 42 has the liquid crystal alignment pattern in which the direction of the optical axis 40A derived from the rod-like liquid crystal compound 40c changes while continuously rotating along at least one in-plane direction. That is, in the present invention, the support 30 may be made to act as the alignment film.

### <Rod-Like Liquid Crystal Layer>

The rod-like liquid crystal layer 42 is formed on a surface of the alignment film 32.

As described above, the rod-like liquid crystal layer 42 is a liquid crystal layer obtained by immobilizing a liquid crystal phase in which the rod-like liquid crystal compound 40c is aligned, and is a liquid crystal layer having a liquid crystal alignment pattern in which the direction of the optical axis derived from the liquid crystal compound changes while continuously rotating along at least one in-plane direction.

In the rod-like liquid crystal layer 42, as conceptually shown in FIG. 4, the rod-like liquid crystal compounds 40c may not be helically twisted and rotated in the thickness direction, and the rod-like liquid crystal compounds 40c at the same position in the plane direction may be aligned such that the directions of the optical axes 40A thereof are directed in the same direction.

### <<Method of Forming Rod-Like Liquid Crystal Layer>>

The rod-like liquid crystal layer can be formed by immobilizing a liquid crystal phase aligned in a liquid crystal alignment pattern in which the direction of the optical axis derived from the liquid crystal compound changes while continuously rotating along at least one in-plane direction in a layer shape.

The structure in which a liquid crystal phase is immobilized may be a structure in which the alignment of the liquid crystal compound as a liquid crystal phase is maintained. Typically, the structure in which a liquid crystal phase is immobilized is preferably a structure which is obtained by aligning the polymerizable liquid crystal compound in the liquid crystal alignment pattern, polymerizing and curing the polymerizable liquid crystal compound with ultraviolet irradiation, heating, or the like to form a layer having no fluidity, and concurrently changing the state of the polymerizable liquid crystal compound into a state where the orientation state is not changed by an external field or an external force.

The structure in which a liquid crystal phase is immobilized is not particularly limited as long as the optical characteristics of the liquid crystal phase are maintained, and the liquid crystal compound in the rod-like liquid crystal layer does not necessarily exhibit liquid crystallinity. For example, the molecular weight of the polymerizable liquid crystal compound may be increased by the curing reaction and the liquid crystallinity may be lost.

These points can also be applied to the disk-like liquid crystal layer described below.

Examples of a material used for forming the rod-like liquid crystal layer obtained by immobilizing a liquid crystal phase include a liquid crystal composition including a liquid crystal compound. The liquid crystal compound is preferably a polymerizable liquid crystal compound.

In addition, the liquid crystal composition used for forming the rod-like liquid crystal layer may further include a surfactant, a polymerization initiator, and the like.

### ——Polymerizable Liquid Crystal Compound——

Examples of the rod-like polymerizable liquid crystal compound for forming the rod-like liquid crystal layer include a rod-like nematic liquid crystal compound. As the rod-like nematic liquid crystal compound, an azomethine compound, an azoxy compound, a cyanobiphenyl compound, a cyanophenyl ester compound, a benzoate compound, a phenyl cyclohexanecarboxylate compound, a cyanophenylcyclohexane compound, a cyano-substituted phenylpyrimidine compound, an alkoxy-substituted phenylpyrimidine compound, a phenyldioxane compound, a tolane compound, an alkenylcyclohexylbenzonitrile compound, or the like is preferably used. Polymer liquid crystal compounds can also be used as well as low-molecular liquid crystal compounds.

The polymerizable liquid crystal compound is obtained by introducing a polymerizable group into the liquid crystal compound. Examples of the polymerizable group include an unsaturated polymerizable group, an epoxy group, and an aziridinyl group. Among these, an unsaturated polymerizable group is preferable, and an ethylenically unsaturated polymerizable group is more preferable. The polymerizable group can be introduced into the molecules of the liquid crystal compound using various methods. The number of polymerizable groups included in the polymerizable liquid crystal compound is preferably 1 to 6 and more preferably 1 to 3. Examples of the polymerizable liquid crystal compound include the compounds described in Makromol. Chem., (1989), Vol. 190, p.2255, Advanced Materials (1993), Vol. 5, p. 107, U.S. Pat. Nos. 4,683,327A, 5,622,648A, 5,770,107A, WO95/22586A, WO95/24455A, WO97/00600A, WO98/23580A, WO98/52905A, JP1989-272551A (JP-H1-272551A), JP1994-16616A (JP-H6-16616A), JP1995-110469A (JP-H7-110469A), JP1999-80081A (JP-H11-80081A), JP2001-328973A, and the like. Two or more polymerizable liquid crystal compounds may be used in combination. In a case where two or more kinds of polymerizable liquid crystal compounds are used in combination, an alignment temperature can be decreased.

In addition, as a polymerizable liquid crystal compound other than the above-described examples, for example, such a cyclic organopolysiloxane compound having a cholesteric phase as described in JP1982-165480A (JP-S57-165480A) can be used. Further, as the above-described polymer liquid crystal compound, for example, a polymer in which a liquid crystal mesogenic group is introduced into the main chain, a side chain, or both the main chain and a side chain, a polymer cholesteric liquid crystal in which a cholesteryl group is introduced into a side chain, such a liquid crystal polymer as described in JP1997-133810A (JP-H9-133810A), and such a liquid crystal polymer as described in JP1999-293252A (JP-H11-293252A) can be used.

The amount of the polymerizable liquid crystal compound added to the liquid crystal composition based on the mass of solid contents (except for solvents) of the liquid crystal composition is preferably 75% to 99.9% by mass, more preferably 80% to 99% by mass, and even more preferably 85% to 90% by mass.

### ——Surfactant——

The liquid crystal composition used for forming the rod-like liquid crystal layer may include a surfactant.

The surfactant is preferably a compound which can function as an alignment control agent contributing to the alignment of the liquid crystal compound in a stable or rapid manner. Examples of the surfactant include a silicone surfactant and a fluorine-based surfactant. Among these, a fluorine-based surfactant is preferable.

Specific examples of the surfactant include the compounds described in paragraphs [0082] to [0090] of JP2014-119605A, the compounds described in paragraphs [0031] to [0034] of JP2012-203237A, the compounds exemplified in paragraphs [0092] and [0093] of JP2005-99248A, the compounds exemplified in paragraphs [0076] to [0078] and paragraphs [0082] to [0085] of JP2002-129162A, and the fluorine (meth)acrylate polymers described in paragraphs [0018] to [0043] of JP2007-272185A, and the like.

The surfactant may be used alone or in combination of two or more kinds thereof.

The fluorine-based surfactant is preferably a compound described in paragraphs [0082] to [0090] of JP2014-119605A.

The adding amount of the surfactant in the liquid crystal composition is preferably 0.01 to 10% by mass, more preferably 0.01 to 5% by mass, and still more preferably 0.02 to 1% by mass with respect to the total mass of the liquid crystal compound.

### ——Polymerization Initiator——

In a case where the liquid crystal composition contains a polymerizable compound, it is preferable that the liquid crystal composition contains a polymerization initiator. In an aspect where a polymerization reaction progresses with ultraviolet irradiation, it is preferable that the polymerization initiator is a photopolymerization initiator which can initiate a polymerization reaction with ultraviolet irradiation.

Examples of the photopolymerization initiator include α-carbonyl compounds (described in U.S. Pat. Nos. 2,367,661A and 2,367,670A), acyloin ether (described in U.S. Pat. No. 2,448,828A), α-hydrocarbon-substituted aromatic acyloin compounds (described in U.S. Pat. No. 2,722,512A), polynuclear quinone compounds (described in U.S. Pat. Nos. 3,046,127A and 2,951,758A), combinations of triarylimidazole dimer and p-aminophenyl ketone (described in U.S. Pat. No. 3,549,367A), acridine compounds and phenazine compounds (described in JP1985-105667A (JP-S60-105667A) and U.S. Pat. No. 4,239,850A), and oxadiazole compounds (described in U.S. Pat. No. 4,212,970A).

The content of the photopolymerization initiator in the liquid crystal composition is preferably 0.1 to 20% by mass and more preferably 0.5 to 12% by mass with respect to the content of the liquid crystal compound.

### ——Crosslinking Agent——

In order to improve a film hardness after curing and to improve durability, the liquid crystal composition may include any crosslinking agent. As the crosslinking agent, a crosslinking agent which cures the liquid crystal composition with ultraviolet rays, heat, humidity, and the like can be suitably used.

The crosslinking agent is not particularly limited and can be appropriately selected according to the purpose, and examples thereof include polyfunctional acrylate compounds such as trimethylolpropane tri(meth)acrylate and pentaerythritol tri(meth)acrylate; epoxy compounds such as glycidyl (meth)acrylate and ethylene glycol diglycidyl ether; aziridine compounds such as 2,2-bishydroxymethylbutanol-tris[3-(1-aziridinyl) propionate] and 4,4-bis(ethyleneiminocarbonylamino); isocyanate compounds such as hexamethylene diisocyanate and biuret-type isocyanate; polyoxazoline compounds having an oxazoline group in the side chain; and alkoxysilane compounds such as vinyltrimethoxysilane and N-(2-aminoethyl) 3-aminopropyltrimethoxysilane. In addition, a well-known catalyst can be used in accordance with reactivity of the crosslinking agent, and it is possible to improve the productivity, in addition to the improvement of the film hardness and durability. These may be used alone or in combination of two or more kinds thereof.

A content of the crosslinking agent is preferably 3% to 20% by mass, and more preferably 5% to 15% by mass with respect to the mass of solid content of the liquid crystal composition. In a case where the content of the crosslinking agent is in the above-described range, an effect of improving a crosslinking density can be easily obtained, and the stability of a liquid crystalline phase is further improved.

### ——Other Additives——

Optionally, a polymerization inhibitor, an antioxidant, an ultraviolet absorber, a light stabilizer, a coloring material, metal oxide fine particles, or the like can be added to the liquid crystal composition in a range where optical performance and the like do not deteriorate.

In a case where the rod-like liquid crystal layer is formed, it is preferable that the liquid crystal composition is used as liquid.

The liquid crystal composition may contain a solvent. The solvent is not particularly limited and can be appropriately selected depending on the purpose. An organic solvent is preferable.

The organic solvent is not limited and may be appropriately selected according to the purpose, and examples thereof include ketones, alkyl halides, amides, sulfoxides, heterocyclic compounds, hydrocarbons, esters, and ethers. These may be used alone or in combination of two or more kinds thereof. Among these, the ketone is preferable in consideration of an environmental burden.

In a case of forming the rod-like liquid crystal layer, it is preferable that the rod-like liquid crystal layer is formed by applying the liquid crystal composition to a surface on which the rod-like liquid crystal layer is to be formed, aligning the liquid crystal compound to a liquid crystal phase aligned in a predetermined liquid crystal alignment pattern, and curing the liquid crystal compound.

That is, in a case where the rod-like liquid crystal layer is formed on the alignment film 32, it is preferable that the rod-like liquid crystal layer obtained by immobilizing the liquid crystal phase is formed by applying the liquid crystal composition to the alignment film 32, aligning the liquid crystal compound to a liquid crystal phase aligned in a predetermined liquid crystal alignment pattern, and curing the liquid crystal compound. In addition, in a case where the disk-like liquid crystal layer is formed on the rod-like liquid crystal layer, it is preferable that the disk-like liquid crystal layer obtained by immobilizing a liquid crystal phase is formed by applying the liquid crystal composition to the rod-like liquid crystal layer, aligning the liquid crystal compound in the predetermined liquid crystal alignment pattern, and curing the liquid crystal compound.

For the application of the liquid crystal composition, a printing method such as ink jet or scroll printing or a well-known method such as spin coating, bar coating, or spray coating capable of uniformly applying liquid to a sheet-like material can be used.

The applied liquid crystal composition is optionally dried and/or heated and then is cured to form the rod-like liquid crystal layer. In the drying and/or heating step, the liquid crystal compound in the liquid crystal composition may be aligned in the predetermined liquid crystal alignment pattern. In a case where heating is performed, the heating temperature is preferably 200° C. or lower and more preferably 130° C. or lower.

The aligned liquid crystal compound is optionally further polymerized. The polymerization may be thermal polymerization or photopolymerization by light irradiation, but photopolymerization is preferable. It is preferable to use ultraviolet rays for the light irradiation. An irradiation energy is preferably 20 mJ/cm² to 50 J/cm² and more preferably 50 to 1,500 mJ/cm². In order to promote a photopolymerization reaction, the light irradiation may be performed under the heating conditions or the nitrogen atmosphere. The wavelength of ultraviolet rays to be emitted is preferably 250 to 430 nm.

### <<Liquid Crystal Alignment Pattern of Rod-Like Liquid Crystal Layer>>

As described above, the rod-like liquid crystal layer has the liquid crystal alignment pattern in which the direction of the optical axis 40A derived from the rod-like liquid crystal compound 40c changes while continuously rotating in the one in-plane direction in a plane of the optically anisotropic layer.

The optical axis 40A derived from the rod-like liquid crystal compound 40c is an axis having the highest refractive index in the rod-like liquid crystal compound 40c, that is, a so-called slow axis. In the rod-like liquid crystal compound 40c, the optical axis 40A is along a rod-like major axis direction.

FIG. 5 conceptually shows a plan view of the rod-like liquid crystal layer 42.

The plan view is a view of the rod-like liquid crystal layer as viewed from above in FIG. 4, that is, a view of the optical element as viewed from a thickness direction (=a lamination direction of the layers (films)).

In addition, in order to clearly show the configuration of the rod-like liquid crystal layer, FIG. 5 shows only the rod-like liquid crystal compound 40c on the surface of the alignment film 32.

As shown in FIG. 5, on the surface of the alignment film 32, the rod-like liquid crystal compound 40c forming the rod-like liquid crystal layer 42 has the liquid crystal alignment pattern in which the direction of the optical axis 40A changes while continuously rotating along the predetermined one in-plane direction indicated by arrow D (hereinafter, referred to as the arrangement axis D) in a plane of the rod-like liquid crystal layer 42 according to the alignment pattern formed on the alignment film 32 as the lower layer. In the example shown in the drawing, the rod-like liquid crystal compound 40c has the liquid crystal alignment pattern in which the optical axis 40A of the rod-like liquid crystal compound 40c changes while continuously rotating clockwise along the arrangement axis D direction.

The rod-like liquid crystal compound 40c forming the rod-like liquid crystal layer 42 is two-dimensionally arranged in a direction perpendicular to the arrangement axis D and the one in-plane direction (arrangement axis D direction).

In the following description, a direction orthogonal to the arrangement axis D direction will be referred to as a “Y direction” for convenience of description. That is, the arrow Y direction is a direction perpendicular to the one in-plane direction in which the direction of the optical axis 40A of the rod-like liquid crystal compound 40c changes while continuously rotating in a plane of the rod-like liquid crystal layer 42. Accordingly, in FIGS. 1 to 4 and FIG. 6 described below, the Y direction is a direction perpendicular to the paper plane.

Specifically, “the direction of the optical axis 40A of the rod-like liquid crystal compound 40c changes while continuously rotating in the arrangement axis D direction (the predetermined one in-plane direction)” represents that an angle between the optical axis 40A of the rod-like liquid crystal compound 40c, which is arranged along the arrangement axis D direction, and the arrangement axis D direction varies depending on positions in the arrangement axis D direction, and the angle between the optical axis 40A and the arrangement axis D direction sequentially changes from 0 to θ+180° or θ−180° along the arrangement axis D direction.

A difference between the angles of the optical axes 40A of the rod-like liquid crystal compound 40c adjacent to each other in the arrangement axis D direction is preferably 45° or less, more preferably 15° or less, and still more preferably less than 15°.

In addition, in the present invention, the liquid crystal compound rotates in the direction in which an angle between the optical axes 40A of the rod-like liquid crystal compound 40c adjacent to each other in the arrangement axis D direction decreases. Accordingly, in the rod-like liquid crystal layer 42 shown in FIGS. 4 and 5, the optical axis 40A of the rod-like liquid crystal compound 40c rotates to the right (clockwise) along the direction indicated by the arrow of the arrangement axis D.

On the other hand, in the rod-like liquid crystal compound 40c forming the rod-like liquid crystal layer 42, the directions of the optical axes 40A are the same in the Y direction perpendicular to the arrangement axis D direction, that is, the Y direction perpendicular to the one in-plane direction in which the optical axis 40A continuously rotates.

In other words, in the rod-like liquid crystal compound 40c forming the rod-like liquid crystal layer 42, angles between the optical axes 40A of the rod-like liquid crystal compounds 40c and the arrangement axis D direction are the same in the Y direction.

In the rod-like liquid crystal layer 42, the angles between the optical axes 40A and the arrangement axis D direction are the same in the liquid crystal compounds arranged in the Y direction. That is, the arrangement axis D direction is the one direction in which the orientation of the optical axis of the rod-like liquid crystal compound 40c changes while continuously rotating.

Regions where the rod-like liquid crystal compounds 40c in which the angles between the optical axes 40A and the arrangement axis D direction are the same are disposed in the Y direction will be referred to as “regions R”.

As described above, in the rod-like liquid crystal layer 42, in the liquid crystal alignment pattern of the rod-like liquid crystal compound 40c, a length (length Λ (distance)) over which the optical axis 40A of the rod-like liquid crystal compound 40c rotates by 180° in the arrangement axis D direction in which the optical axis 40A changes while continuously rotating in a plane is set as the single period Λ in the liquid crystal alignment pattern. That is, a distance between centers of two rod-like liquid crystal compounds 40c in the arrangement axis D direction is the length Λ of the single period, the two liquid crystal compounds having the same angle in the arrangement axis D direction. Specifically, as shown in FIG. 5, a distance between centers of two rod-like liquid crystal compounds 40c in the arrangement axis D direction, in which the arrangement axis D direction and the direction of the optical axis 40A match with each other, is set as the single period Λ.

In the liquid crystal alignment pattern of the rod-like liquid crystal layer 42, the single period Λ is repeated in the arrangement axis D direction, that is, in the one in-plane direction in which the direction of the optical axis 40A changes while continuously rotating.

Here, in the optical element according to the embodiment of the present invention, the single period Λ is shorter than 0.5 μm. That is, in the present invention, the optical axis 40A rotates by 180° in a period shorter than 0.5 μm along the arrangement axis D repeatedly.

Regarding this point, the same applies to the disk-like liquid crystal layer 44

In FIG. 4, the rod-like liquid crystal compounds 40c present at the same position in a plane are aligned in the thickness direction such that the optical axes 40A thereof face the same direction. However, as in the example shown in FIG. 2, in the rod-like liquid crystal layer 42b and the disk-like liquid crystal layer 44b that are alternately laminated, in a case where the longitudinal direction of the liquid crystal compound is twisted and aligned in the thickness direction, the optical axis 40A of the rod-like liquid crystal compound 40c in each of the layers is twisted and aligned in the thickness direction. This point can also be applied to the disk-like liquid crystal layer.

### <Disk-Like Liquid Crystal Layer>

Hereinafter, the disk-like liquid crystal layer 44 will be described using FIGS. 6 and 7.

The examples shown in FIGS. 6 and 7 are disk-like liquid crystal layers that are formed by immobilizing a liquid crystal phase in which a disk-like liquid crystal compound is aligned and that have a liquid crystal alignment pattern in which the orientation of the optical axis derived from the liquid crystal compound changes while continuously rotating along at least one in-plane direction.

In a case where the disk-like liquid crystal layer 44 is laminated on the rod-like liquid crystal layer 42 as in the disk-like liquid crystal layer 44 of the optical element 10 in FIG. 1, the disk-like liquid crystal layer 44 may be directly formed and laminated on the rod-like liquid crystal layer 42, or may be formed on a support and an alignment film and then the support and the alignment film may be peeled off to be laminated on the rod-like liquid crystal layer 42 as in the rod-like liquid crystal layer 42 in FIG. 4.

As described above, the disk-like liquid crystal layer 44 is a liquid crystal layer formed by immobilizing a liquid crystal phase in which a disk-like liquid crystal compound 40d is aligned and has a liquid crystal alignment pattern in which the orientation of the optical axis derived from the liquid crystal compound changes while continuously rotating along at least one in-plane direction. The optical axis of the disk-like liquid crystal compound 40d faces a direction perpendicular to a disc plane. Therefore, in the disk-like liquid crystal layer 44, the disk-like liquid crystal compound 40d is arranged such that the disc plane is perpendicular to the interface (surface) of the disk-like liquid crystal layer 44.

In the disk-like liquid crystal layer 44, as conceptually shown in FIG. 6, the disk-like liquid crystal compounds 40d may not be helically twisted and rotated in the thickness direction, and the disk-like liquid crystal compounds 40d at the same position in the plane direction may be aligned such that the directions of the optical axes 40A thereof are directed in the same direction.

### <<Method of Forming Disk-Like Liquid Crystal Layer>>

The disk-like liquid crystal layer can be formed by immobilizing a liquid crystal phase in a layer shape, the liquid crystal phase being aligned in a liquid crystal alignment pattern in which the orientation of the optical axis derived from the liquid crystal compound changes while continuously rotating along at least one in-plane direction.

Examples of a material used for forming the disk-like liquid crystal layer obtained by immobilizing a liquid crystal phase include a liquid crystal composition including a liquid crystal compound. The liquid crystal compound is preferably a polymerizable liquid crystal compound.

In addition, as in the liquid crystal composition used for forming the rod-like liquid crystal layer, the liquid crystal composition used for forming the disk-like liquid crystal layer may further include additives such as a surfactant or a polymerization initiator and a solvent. The additives such as a surfactant or a polymerization initiator and the solvent are as described above.

### ——Disk-Like Liquid Crystal Compound——

As the disk-like liquid crystal compound, for example, compounds described in JP2007-108732A and JP2010-244038A can be preferably used.

In a case where the disk-like liquid crystal layer is formed, it is preferable that the disk-like liquid crystal layer is formed by applying the liquid crystal composition to a surface where the disk-like liquid crystal layer is to be formed, aligning the liquid crystal compound to a state the liquid crystal phase aligned in the predetermined liquid crystal alignment pattern, and curing the liquid crystal compound.

That is, in a case where the disk-like liquid crystal layer is formed on the alignment film, it is preferable that the disk-like liquid crystal layer obtained by immobilizing a liquid crystal phase is formed by applying the liquid crystal composition to the alignment film, aligning the liquid crystal compound in the predetermined liquid crystal alignment pattern, and curing the liquid crystal compound. In addition, in a case where the disk-like liquid crystal layer is formed on the rod-like liquid crystal layer, it is preferable that the disk-like liquid crystal layer obtained by immobilizing a liquid crystal phase is formed by applying the liquid crystal composition to the rod-like liquid crystal layer, aligning the liquid crystal compound in the predetermined liquid crystal alignment pattern, and curing the liquid crystal compound.

However, the present invention is not limited thereto, and an alignment film for forming the disk-like liquid crystal layer 44 or a support may be provided between the disk-like liquid crystal layer 44 and the rod-like liquid crystal layer 42, as in the rod-like liquid crystal layer 42 described above.

An application method, a drying and heating method after the application, and a polymerization method of the liquid crystal composition are as described above.

In a case where the liquid crystal layer is formed on the liquid crystal layer by the application method, basically, the liquid crystal layer of the upper layer follows the alignment state of the liquid crystal compound on the surface (interface) of the liquid crystal layer of the lower layer.

### <<Liquid Crystal Alignment Pattern of Disk-Like Liquid Crystal Layer>>

As described above, the disk-like liquid crystal layer has the liquid crystal alignment pattern in which the direction of the optical axis 40A derived from the disk-like liquid crystal compound 40d changes while continuously rotating in the one in-plane direction in a plane of the optically anisotropic layer.

The optical axis 40A derived from the disk-like liquid crystal compound 40d is an axis perpendicular to the disc plane of the disk-like liquid crystal compound 40d.

FIG. 7 conceptually shows a plan view of the disk-like liquid crystal layer 44.

The plan view is a view of the disk-like liquid crystal layer in FIG. 6 as viewed from above, that is, a view of the optical element as viewed from a thickness direction (=a lamination direction of the respective layers (films)).

In addition, in order to clearly show the configuration of the disk-like liquid crystal layer, FIG. 7 shows only the disk-like liquid crystal compound 40d on the surface (interface) of the disk-like liquid crystal layer 44.

As shown in FIG. 7, the disk-like liquid crystal compound 40d forming the disk-like liquid crystal layer 44 has the liquid crystal alignment pattern in which the direction of the optical axis 40A changes while continuously rotating along one predetermined direction indicated by the arrangement axis D in a plane of the disk-like liquid crystal layer 44. In the example shown in the drawing, the disk-like liquid crystal compound 40d has the liquid crystal alignment pattern in which the optical axis 40A of the disk-like liquid crystal compound 40d changes while continuously rotating clockwise along the arrangement axis D direction.

The disk-like liquid crystal compound 40d forming the disk-like liquid crystal layer 44 is two-dimensionally arranged in the Y direction perpendicular to the arrangement axis D and the one in-plane direction (arrangement axis D direction).

In the liquid crystal compounds arranged in the Y direction in the disk-like liquid crystal layer 44, the angles between the optical axes 40A and the arrangement axis D direction are the same. Regions where the disk-like liquid crystal compounds 40d in which the angles between the optical axes 40A and the arrangement axis D direction are the same are disposed in the Y direction will be referred to as “regions R”.

Similarly to the rod-like liquid crystal layer 42, in the disk-like liquid crystal layer 44, in the liquid crystal alignment pattern of the disk-like liquid crystal compound 40d, a length (length Λ (distance)) over which the optical axis 40A of the disk-like liquid crystal compound 40d rotates by 180° in the arrangement axis D direction in which the optical axis 40A changes while continuously rotating in a plane is set as a single period Λ in the liquid crystal alignment pattern.

That is, a distance between centers of two disk-like liquid crystal compounds 40d in the arrangement axis D direction is the length Λ of the single period, the two liquid crystal compounds having the same angle in the arrangement axis D direction. Specifically, as shown in FIG. 7, a distance between centers in the arrangement axis D direction of two disk-like liquid crystal compounds 40d in which the arrangement axis D direction and the direction of the optical axis 40A match with each other is the length Λ of the single period.

In the liquid crystal alignment pattern of the disk-like liquid crystal layer 44, the single period Λ is repeated in the arrangement axis D direction, that is, in the one in-plane direction in which the direction of the optical axis 40A changes while continuously rotating.

As described above, in the optical element according to the embodiment of the present invention, the single period Λ is shorter than 0.5 μm. That is, in the present invention, even in the disk-like liquid crystal layer 44, the optical axis 40A repeatedly rotates by 180° at a period shorter than 0.5 μm along the arrangement axis D.

Here, as described above, at least at an interface between the rod-like liquid crystal layer 42 and the disk-like liquid crystal layer 44, regarding the rod-like liquid crystal compound 40c and the disk-like liquid crystal compound 40d present at the same position in the plane direction, a longitudinal direction of the rod-like liquid crystal compound 40c and a longitudinal direction of a shape obtained by projecting the disk-like liquid crystal compound 40d to the interface of the disk-like liquid crystal layer 44 match with each other. Therefore, as in the example shown in FIG. 1, in the rod-like liquid crystal layer 42b and the disk-like liquid crystal layer 44b that are laminated, the rod-like liquid crystal compound 40c and the disk-like liquid crystal compound 40d present at the same position in the plane direction are aligned such that the longitudinal directions thereof face the same direction in the entire thickness direction.

In the optical element 10 in which the rod-like liquid crystal layer 42 and the disk-like liquid crystal layer 44 are alternately laminated, it is preferable that the value of the in-plane retardation (Re) in each of the regions R is a half wavelength, that is, λ/2. The in-plane retardation is calculated from the product of the difference Δn in refractive index due to the refractive index anisotropy of the region R and the thickness of the optical element 10.

Here, the difference in refractive index due to the refractive index anisotropy of the region R in the optical element 10 depends on a difference between the refractive index of the rod-like liquid crystal compound 40c in the longitudinal direction and the refractive index in the direction perpendicular to the longitudinal direction (difference in refractive index of the rod-like liquid crystal compound 40c) and a difference between the refractive index of the disk-like liquid crystal compound 40d in the longitudinal direction and the refractive index in the direction perpendicular to the longitudinal direction (difference in refractive index of the disk-like liquid crystal compound 40d). Accordingly, the in-plane retardation in the region R of the optical element 10 is determined depending on the difference in refractive index of the rod-like liquid crystal compound 40c, the difference in refractive index of the disk-like liquid crystal compound 40d, the thickness of the rod-like liquid crystal compound 40c, the thickness of the disk-like liquid crystal compound 40d, and the like.

Such an optical element 10 refracts incident circularly polarized light and generates an action of converting the polarization direction of the circularly polarized light.

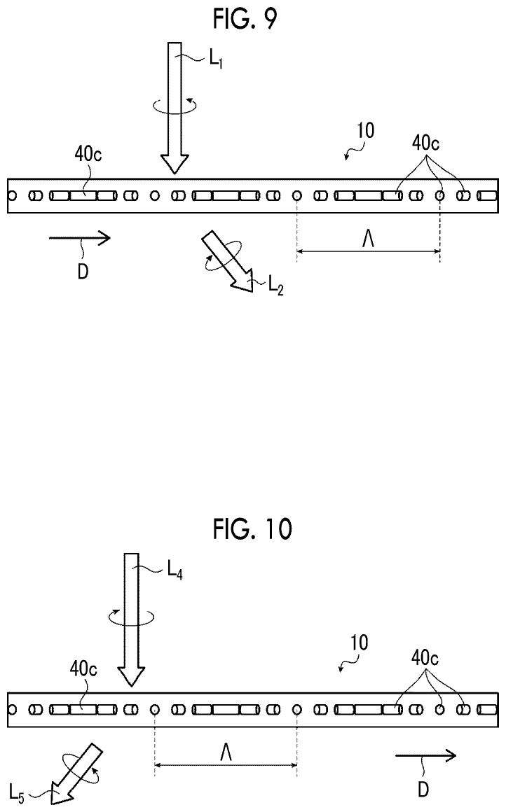

The action of the optical element 10 will be described using conceptual views shown in FIGS. 9 and 10.

In the optical element 10, the value of the product of the difference in refractive index of the liquid crystal compound and the thickness of the optical element is λ/2. In addition, in FIGS. 9 and 10, only the rod-like liquid crystal compound 40c on the surface is shown in order to show the rotation direction of the optical axis in the liquid crystal alignment pattern of the optical element 10, but the optical element 10 includes the laminated rod-like liquid crystal layer 42 and disk-like liquid crystal layer 44 as in the example shown in FIG. 1.

As shown in FIG. 9, in a case where the value of the product of the difference in refractive index of the liquid crystal compound of the optical element 10 and the thickness of the optical element 10 is λ/2, in a case where incident light L₁ as levorotatory circularly polarized light is incident into the optical element 10, the incident light L₁ transmits through the optical element 10 to be imparted with a phase difference of 180°, and transmitted ray L₂ is converted into dextrorotatory circularly polarized light.

In addition, the liquid crystal alignment pattern formed in the optical element 10 is a pattern that is periodic in the arrangement axis D direction. Therefore, the transmitted ray L₂ travels in a direction different from the traveling direction of the incident light L₁. In this way, the levorotatory circularly polarized incident rays L₁ are converted into dextrorotatory circularly polarized transmission rays L₂, which are tilted by a predetermined angle in the arrangement axis D direction with respect to an incidence direction. In the example shown in FIG. 9, the transmitted light L₂ is diffracted to travel in the lower right direction.

On the other hand, as shown in FIG. 10, in a case where the value of the product of the difference in refractive index of the liquid crystal compound of the optical element 10 and the thickness of the rod-like liquid crystal layer 42 is λ/2, in a case where incident light L₄ as dextrorotatory circularly polarized light is incident into the optical element 10, the incident light L₄ transmits through the optical element 10 to be imparted with a phase difference of 180°, and transmitted ray L₅ is converted into levorotatory circularly polarized light.

In addition, the liquid crystal alignment pattern formed in the optical element 10 is a pattern that is periodic in the arrangement axis D direction. Therefore, the transmitted ray L₅ travels in a direction different from the traveling direction of the incident light L₄. In this case, the transmission rays L₅ travel in a direction different from the transmission rays L₂, that is, in a direction opposite to the arrow direction of the arrangement axis D with respect to the incidence direction. In this way, the incident ray L₄ is converted into the transmitted ray L₅ of the levorotatory circularly polarized light, which is tilted by a predetermined angle in a direction opposite to the arrangement axis D direction with respect to the incidence direction. In the example shown in FIG. 10, the transmitted light L₅ is diffracted to travel in the lower left direction.

As described above, in the optical element 10, the refraction angles of the transmitted rays L₂ and L₅ can be adjusted by the length of the single period Λ of the formed liquid crystal alignment pattern.

Specifically, in the optical element 10, as the single period Λ of the liquid crystal alignment pattern decreases, light components transmitted through the liquid crystal compounds adjacent to each other more strongly interfere with each other. Therefore, the transmitted rays L₂ and L₅ can be more largely refracted.

Here, in the optical element 10 according to the embodiment of the present invention, both the rod-like liquid crystal layer 42 and the disk-like liquid crystal layer 44 have a single period Λ of less than 0.5 μm. That is, in the optical element 10 according to the embodiment of the present invention, the transmitted ray can be diffracted (refracted) at a large diffraction angle with respect to the incident light.

In addition, as described above, the optical element 10 according to the embodiment of the present invention has a configuration in which the rod-like liquid crystal layer 42 and the disk-like liquid crystal layer 44 having the same liquid crystal alignment pattern are laminated directly or with the support 30 or the like interposed therebetween. Therefore, in the optical element 10 according to the embodiment of the present invention, the incident light can be diffracted with a high diffraction efficiency with a small amount of zero-order light or the like.

That is, with the optical element according to the embodiment of the present invention, the incident light can be diffracted (refracted) at a large diffraction angle with a high diffraction efficiency.

In addition, by reversing the rotation direction of the optical axis 40A of the liquid crystal compound that rotates along the arrangement axis D direction, the refraction direction of transmitted light can be reversed.

That is, in the example shown in FIGS. 9 and 10, the rotation direction of the optical axis 40A toward the arrangement axis D direction is clockwise. By setting this rotation direction to be counterclockwise, the refraction direction of transmitted light can be reversed. Specifically, in FIGS. 9 and 10, in a case where the rotation direction of the optical axis 40A in the arrangement axis D direction is counterclockwise, levorotatory circularly polarized light incident into the optical element 10 from the upper side in the drawing is converted into dextrorotatory circularly polarized light as transmitted light through the optical element 10 and is diffracted to travel in the lower left direction in the drawing. In addition, dextrorotatory circularly polarized light incident into the optical element 10 from the upper side in the drawing is converted into levorotatory circularly polarized light as transmitted light through the optical element 10 and is diffracted to travel in the lower right direction in the drawing.

### <<Method of Manufacturing Optical Element>>

The optical element can be manufactured by forming each of the rod-like liquid crystal layer and the disk-like liquid crystal layer using the above-described methods.

That is, for example, first, a pattern alignment film is formed on a support, and a liquid crystal composition serving as a rod-like liquid crystal layer is applied onto the pattern alignment film, dried, heated, and cured to form a rod-like liquid crystal layer 42. Next, a liquid crystal composition serving as a disk-like liquid crystal layer may be applied onto the rod-like liquid crystal layer 42, dried, heated, and cured to form a disk-like liquid crystal layer 44.

As described above, in a case where a liquid crystal layer is formed on a liquid crystal layer using a coating method, basically, the liquid crystal layer of the upper layer follows the alignment state of the liquid crystal compound on the surface (interface) of the liquid crystal layer of the lower layer.

In a case where an optical element including a plurality of rod-like liquid crystal layers and a plurality of disk-like liquid crystal layers is manufactured by alternately laminating the rod-like liquid crystal layers and the disk-like liquid crystal layers, the formation of the rod-like liquid crystal layer 42 and the disk-like liquid crystal layer 44 may be alternately repeated.

In the above-described example, the rod-like liquid crystal layer is formed on the pattern alignment film on the support, but the present invention is not limited thereto. The disk-like liquid crystal layer may be formed on the pattern alignment film on the support, and then the rod-like liquid crystal layer may be formed.

In addition, after the optical element is manufactured, the support and the pattern alignment film may be peeled off.

Alternatively, the rod-like liquid crystal layer 42 and the disk-like liquid crystal layer 44 may be separately manufactured, and the rod-like liquid crystal layer 42 and the disk-like liquid crystal layer 44 may be bonded to each other using an adhesive layer to manufacture the optical element according to the embodiment of the present invention. In this case, an alignment film or a support may be provided between the rod-like liquid crystal layer 42 and the disk-like liquid crystal layer 44.

Here, as described above, in order to allow the rod-like liquid crystal layer and the disk-like liquid crystal layer to have the configuration in which the liquid crystal compound is twisted and aligned in the thickness direction, the liquid crystal compositions for forming the rod-like liquid crystal layer and the disk-like liquid crystal layer may include a chiral agent.

### ——Chiral Agent (Optically Active Compound)——

The chiral agent has a function of inducing a helical structure of a liquid crystal phase. The chiral agent may be selected depending on the purposes since a helical twisted direction and a helical twisting power (HTP) to be induced vary depending on compounds.

The chiral agent is not particularly limited, and a well-known compound (for example, Liquid Crystal Device Handbook (No. 142 Committee of Japan Society for the Promotion of Science, 1989), Chapter 3, Article 4-3, chiral agent for twisted nematic (TN) or super twisted nematic (STN), p. 199), isosorbide, or an isomannide derivative can be used.

In general, the chiral agent includes a chiral carbon atom. However, an axially chiral compound or a planar chiral compound not having a chiral carbon atom can also be used as the chiral agent. Examples of the axially chiral compound or the planar chiral compound include binaphthyl, helicene, paracyclophane, and derivatives thereof. The chiral agent may also have a polymerizable group. In a case where both the chiral agent and the liquid crystal compound have a polymerizable group, a polymer having a repeating unit induced from the polymerizable liquid crystal compound and a repeating unit induced from the chiral agent can be formed by a polymerization reaction between the polymerizable chiral agent and the polymerizable liquid crystal compound. In this aspect, it is preferable that the polymerizable group in the polymerizable chiral agent is the same as the polymerizable group in the polymerizable liquid crystal compound. Accordingly, the polymerizable group of the chiral agent is preferably an unsaturated polymerizable group, an epoxy group, or an aziridinyl group, more preferably an unsaturated polymerizable group, and still more preferably an ethylenically unsaturated polymerizable group.

Further, the chiral agent may be a liquid crystal compound.

In a case where the chiral agent includes a photoisomerization group, a desired twisted alignment corresponding to a luminescence wavelength can be formed by irradiation of an actinic ray or the like through a photomask after coating and alignment, which is preferable. As the photoisomerizable group, an isomerizable site of a compound exhibiting photochromic properties, an azo group, an azoxy group, or a cinnamoyl group is preferable. As specific compounds, compounds described in JP2002-080478A, JP2002-080851A, JP2002-179668A, JP2002-179669A, JP2002-179670A, JP2002-179681A, JP2002-179682A, JP2002-338575A, JP2002-338668A, JP2003-313189A, and JP2003-313292A can be used.

The content of the chiral agent in the liquid crystal composition is preferably 0.01% to 200% by mole, and more preferably 1% to 30% by mole with respect to the molar content of the liquid crystal compound.

Here, in the optical element shown in FIG. 1, the configuration where the optical axis of the liquid crystal compound is parallel to the main surface of the optically anisotropic layer is shown, but the present invention is not limited thereto. In the optical element, the optical axis of the liquid crystal compound may be tilted with respect to the main surface of the optical element (liquid crystal layer).

In addition, the optical axes 40A of the liquid crystal compounds in the liquid crystal alignment patterns of the rod-like liquid crystal layer 42 shown in FIG. 5 and the disk-like liquid crystal layer 44 shown in FIG. 7 continuously rotate only in the arrangement axis D direction.

However, the present invention is not limited thereto, and various configurations can be used as long as the optical axes 40A of the liquid crystal compounds in the rod-like liquid crystal layer 42 and the disk-like liquid crystal layer 44 continuously rotate along the one in-plane direction.

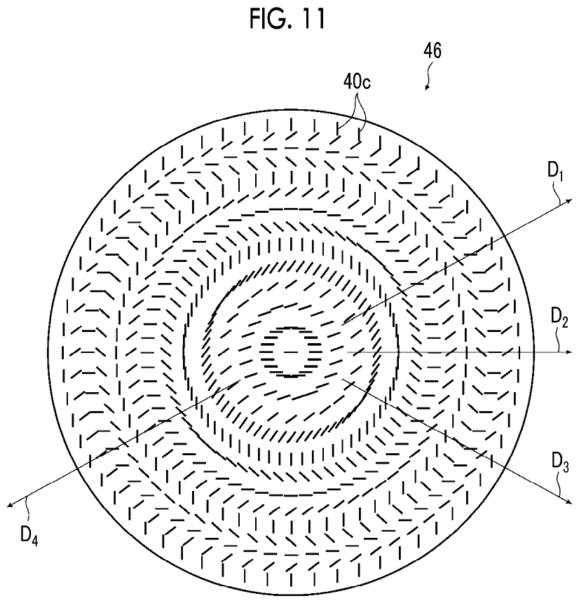

FIG. 11 shows the example. FIG. 11 is a plan view of a rod-like liquid crystal layer 46.

Although FIG. 11 shows only the rod-like liquid crystal layer 46, in the optical element according to the embodiment of the present invention, as in each example described above, a disk-like liquid crystal layer having the same liquid crystal alignment pattern is laminated on the rod-like liquid crystal layer 46. In addition, as in each example described above, the action and effect as the liquid crystal diffraction element are the same in the rod-like liquid crystal layer and the disk-like liquid crystal layer.

In addition, FIG. 11 shows only the alignment state of the rod-like liquid crystal compound on the surface (underlayer interface side) of the alignment film, but as shown in FIG. 4, the rod-like liquid crystal compound 40c has a structure in which the rod-like liquid crystal compounds 40c are laminated, as in each example described above.

The rod-like liquid crystal layer 46 shown in FIG. 11 has a liquid crystal alignment pattern in which the direction of the optical axis derived from the rod-like liquid crystal compound 44c changes while continuously rotating in the one direction in a radial shape from the inner side toward the outer side.

That is, the liquid crystal alignment pattern of the rod-like liquid crystal layer 46 shown in FIG. 11 is a concentric circular pattern in which the one direction in which the direction of the optical axis derived from the rod-like liquid crystal compound 44c changes while continuously rotating is concentrically provided from the inner side toward the outer side.

As described above, the direction of the optical axis of the rod-like liquid crystal compound 44c matches the longitudinal direction of the rod-like liquid crystal compound 44c.

Specifically, in the rod-like liquid crystal layer 46, the direction of the optical axis of the rod-like liquid crystal compound 44c changes while continuously rotating along a plurality of directions radially outward from the center of the rod-like liquid crystal layer 46, for example, a direction indicated by an arrow D₁, a direction indicated by an arrow D₂, a direction indicated by an arrow D₃, a direction indicated by an arrow D₄, or . . . .

In the rod-like liquid crystal layer 46, the rotation direction of the optical axis of the rod-like liquid crystal compound 44c is the same in all directions, that is, in all the one directions. In the example shown in the drawing, the rotation direction of the optical axis of the rod-like liquid crystal compound 44c is counterclockwise in all the directions of the direction indicated by the arrow D₁, the direction indicated by the arrow D₂, the direction indicated by the arrow D₃, and the direction indicated by the arrow D₄.

That is, in a case where the arrow D₁ and the arrow D₄ are regarded as one straight line, the rotation direction of the optical axis of the rod-like liquid crystal compound 44c is reversed at the center of the rod-like liquid crystal layer 46 on the straight Iine. As an example, it is assumed that the straight Iine formed by the arrow D₁ and the arrow D₄ is directed toward the right direction (arrow D₁ direction) in the figure. In this case, the optical axis of the rod-like liquid crystal compound 44c initially rotates clockwise from the outer direction of the rod-like liquid crystal layer 46 toward the center, the rotation direction is reversed at the center of the rod-like liquid crystal layer 46, and then the optical axis rotates counterclockwise from the center of the rod-like liquid crystal layer 46 toward the outer direction.

In addition, the rod-like liquid crystal layer 46 has a liquid crystal alignment pattern in which the single period Λ gradually decreases from the inner side toward the outer side of the concentric circle.

In the rod-like liquid crystal layer 46, the single period Λ of the liquid crystal alignment pattern is shorter than 0.5 μm as in the above-described example.

In the rod-like liquid crystal layer 46 having the concentric liquid crystal alignment pattern shown in FIG. 11, the directions of the arrows D₁, D₂, . . . from the center toward the outer side correspond to the arrangement axis D in FIG. 5, and the direction of each of the concentric circles corresponds to the arrow Y direction in FIG. 5. Accordingly, in the rod-like liquid crystal layer 46 having the concentric liquid crystal alignment pattern, in each of the circles constituting the concentric circle, the orientation of the rod-like liquid crystal compound 40c in the longitudinal direction, that is, the direction of the optical axis is the same.

Even in the rod-like liquid crystal layer 46 having the concentric liquid crystal alignment pattern shown in FIG. 11, the incident light is diffracted as in the rod-like liquid crystal layer 42 having the liquid crystal alignment pattern in which the optical axis changes while rotating in the one direction with respect to the arrow D direction.

Accordingly, the rod-like liquid crystal layer 46 having the concentric liquid crystal alignment pattern shown in FIG. 11 diffracts the incident light toward the center of the concentric circle or diffracts the incident light from the center of the concentric circle toward the outer direction.

Here, as described above, in the liquid crystal alignment pattern of the rod-like liquid crystal layer 46, the single period Λ gradually decreases from the inner side toward the outer side of the concentric circle. Accordingly, the rod-like liquid crystal layer 46 collects the transmitted light toward the center of the concentric circle or emits the transmitted light from the center of the concentric circle toward the outer side. That is, the rod-like liquid crystal layer 46 acts as a convex lens that collects light or a concave lens that emits light depending on the revolution direction of the incident circularly polarized light.

As described above, the same action and effect are exhibited even in the disk-like liquid crystal layer having the same liquid crystal alignment pattern.

Accordingly, as shown in FIG. 11, the optical element according to the embodiment of the present invention in which the rod-like liquid crystal layer and the disk-like liquid crystal layer having the concentric liquid crystal alignment pattern are laminated acts as a liquid crystal lens that collects or emits incident light with high diffraction efficiency and a short focal length.

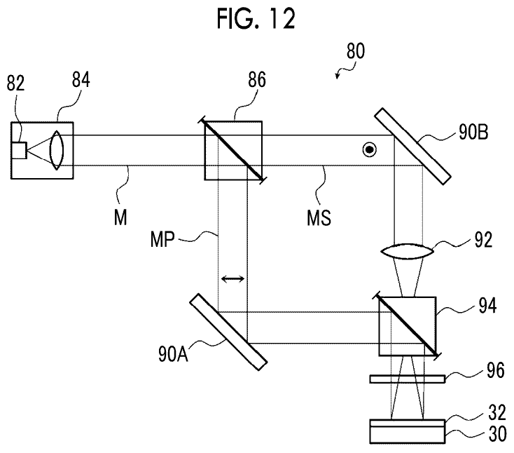

FIG. 12 conceptually shows an example of an exposure device that forms the concentric circular alignment pattern in the alignment film.

An exposure device 80 includes: a light source 84 that comprises a laser 82; a polarization beam splitter 86 that splits the laser light M emitted from the laser 82 into S polarized light MS and P polarized light MP; a mirror 90A that is disposed on an optical path of the P polarized light MP; a mirror 90B that is disposed on an optical path of the S polarized light MS; a lens 92 that is disposed on the optical path of the S polarized light MS; a polarization beam splitter 94; and a λ/4 plate 96.

The P-polarized light MP which is split by the polarization beam splitter 86 is reflected from the mirror 90A to be incident into the polarization beam splitter 94. On the other hand, the S-polarized light MS which is split by the polarization beam splitter 86 is reflected from the mirror 90B and is collected by the lens 92 to be incident into the polarization beam splitter 94.

The P polarized light MP and the S polarized light MS are combined by the polarization beam splitter 94, are converted into dextrorotatory circularly polarized light and levorotatory circularly polarized light by the λ/4 plate 96 depending on the polarization direction, and are incident into the alignment film 24 on the support 20.

Due to interference between the dextrorotatory circularly polarized light and the levorotatory circularly polarized light, the polarization state of light with which the alignment film 24 is irradiated periodically changes according to interference fringes.

Since an intersecting angle between the levorotatory circularly polarized light and the dextrorotatory circularly polarized light changes from an inside toward an outside of concentric circles, an exposure pattern in which pitches change from the inside toward the outside is obtained. As a result, in the alignment film 24, a concentric circular alignment pattern in which the alignment state periodically changes can be obtained.

In the exposure device 80, the length Λ of the single period in the liquid crystal alignment pattern in which the optical axis of the rod-like liquid crystal compound 40c changes while continuously rotating by 180° can be controlled by changing the optical power of the lens 92 (F number of the lens 92), the focal length of the lens 92, the distance between the lens 92 and the alignment film 24, and the like.

In addition, by adjusting the optical power of the lens 92 (F number of the lens 92), the length Λ of the single period in the liquid crystal alignment pattern can be changed in the one direction in which the optical axis changes while continuously rotating. Specifically, the length Λ of the single period in the liquid crystal alignment pattern in the in-plane direction in which the optical axis continuously rotates can be changed depending on a light spread angle at which light is spread by the lens 92 due to interference with parallel light. More specifically, in a case where the optical power of the lens 92 is decreased, the light becomes close to the parallel light. Thus, the length Λ of single period of the liquid crystal alignment pattern is gradually decreased from the inside toward the outside, and the F-number is increased. Conversely, in a case where the optical power of the lens 92 is increased, the length Λ of single period of the liquid crystal alignment pattern is rapidly decreased from the inside toward the outside, and the F-number is decreased.

The optical element according to the embodiment of the present invention described above is a transmission-type optical element (transmission-type liquid crystal diffraction element) that diffracts and transmits incident light. However, the present invention is not limited thereto.

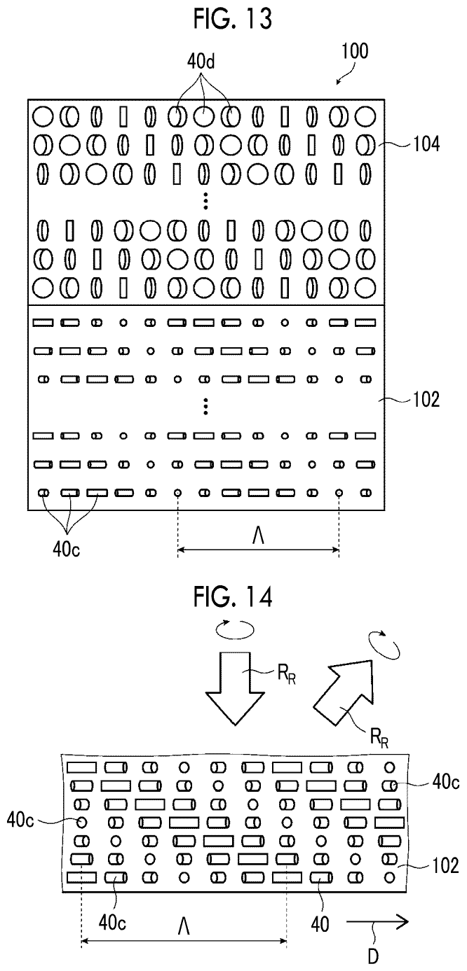

That is, the optical element according to the embodiment of the present invention may be a reflective liquid crystal diffraction element that diffracts and reflects incident light. FIG. 13 conceptually shows the example.

An optical element 100 according to the embodiment of the present invention shown in FIG. 13 includes a rod-like liquid crystal layer 102 and a disk-like liquid crystal layer 104.

Both the rod-like liquid crystal layer 102 and the disk-like liquid crystal layer 104 are cholesteric liquid crystal layers obtained by immobilizing a cholesteric liquid crystalline phase.

Specifically, the rod-like liquid crystal layer 102 is a cholesterically aligned layer in which a rod-like liquid crystal compound 40c is helically twisted and aligned in the thickness direction by 360° or more. That is, the rod-like liquid crystal layer 102 is a cholesteric liquid crystal layer having a helical structure in which the rod-like liquid crystal compounds 40c are helically turned and laminated, in which a configuration in which the rod-like liquid crystal compound 40c is helically rotated once (rotated by) 360° and laminated is a helical pitch P, and a plurality of pitches of the rod-like liquid crystal compounds 40c helically turned are laminated.

On the other hand, the disk-like liquid crystal layer 104 is a cholesterically aligned layer in which a disk-like liquid crystal compound 40d is helically twisted and aligned in the thickness direction by 360° or more. That is, the disk-like liquid crystal layer 104 is a cholesteric liquid crystal layer having a helical structure in which the disk-like liquid crystal compounds 40d are helically turned and laminated, in which a configuration in which the rod-like liquid crystal compound 40c is helically rotated once and laminated is a helical pitch P, and a plurality of pitches of the disk-like liquid crystal compounds 40d helically turned are laminated.

As is well known, the cholesteric liquid crystal layer selectively reflects specific circularly polarized light in a specific wavelength range and allows transmission of the other light.

In the cholesteric liquid crystal layer, a wavelength range showing selective reflectivity, that is, a central wavelength of selective reflection (selective reflection central wavelength λ) depends on a length of the helical pitch in the cholesteric liquid crystalline phase and follows a relationship of λ=n×P between an average refractive index n of the cholesteric liquid crystalline phase and λ.

Therefore, the selective reflection central wavelength, that is, the selective reflection wavelength range can be adjusted by adjusting the helical pitch. The selective reflection central wavelength of the cholesteric liquid crystalline phase increases as the helical pitch P increases.

The helical pitch of the cholesteric liquid crystalline phase depends on the type of the chiral agent used together with the liquid crystal compound, and the concentration of the chiral agent added during the formation of the cholesteric liquid crystal layer. Therefore, a desired helical pitch can be obtained by adjusting these conditions.

The details of the adjustment of the pitch can be found in “Fuji Film Research & Development” No. 50 (2005), pp. 60 to 63. As a method of measuring a sense of helix and a helical pitch, a method described in “Introduction to Liquid Crystal Chemistry Experiment”, (the Japanese Liquid Crystal Society, 2007, Sigma Publishing Co., Ltd.), p. 46, and “Liquid Crystal Handbook” (the Editing Committee of Liquid Crystal Handbook, Maruzen Publishing Co., Ltd.), p. 196 can be used.

In addition, a half-width Δλ (nm) of a wavelength range where selective reflection is exhibited (circular polarization reflection wavelength range) depends on Δn of the cholesteric liquid crystalline phase and the helical pitch P, and complies with a relationship of Δλ=Δn×P. Therefore, the width of the selective reflection wavelength range can be controlled by adjusting Δn. An can be adjusted by adjusting a kind of a liquid crystal compound for forming the cholesteric liquid crystal layer and a mixing ratio thereof, and a temperature during alignment immobilization.

In addition, as is well known, the cholesteric liquid crystalline phase exhibits selective reflectivity with respect to left or right circularly polarized light in a specific wavelength range. Whether or not the reflected light is dextrorotatory circularly polarized light or levorotatory circularly polarized light is determined depending on a helically twisted direction (sense) of the cholesteric liquid crystalline phase. Regarding the selective reflection of the circular polarization by the cholesteric liquid crystalline phase, in a case where the helically twisted direction of the cholesteric liquid crystalline phase is right, dextrorotatory circularly polarized light is reflected, and in a case where the helically twisted direction of the cholesteric liquid crystalline phase is left, levorotatory circularly polarized light is reflected.

The turning direction of the cholesteric liquid crystalline phase can be adjusted by the kind of the liquid crystal compound forming the cholesteric liquid crystal layer and/or the kind of the chiral agent to be added.

Here, in the optical element according to the embodiment of the present invention, the rod-like liquid crystal layer 102 has a liquid crystal alignment pattern in which the optical axis changes while continuously rotating along one direction (arrangement axis D) as shown in FIG. 5, as in the rod-like liquid crystal layer 42 described above. In addition, as in the above-described example, in the rod-like liquid crystal layer 102, the single period Λ in the liquid crystal alignment pattern is 0.5 μm or less.

On the other hand, the disk-like liquid crystal layer 104 has a liquid crystal alignment pattern in which the optical axis changes while continuously rotating along one direction (arrangement axis D) as shown in FIG. 7, as in the disk-like liquid crystal layer 44 described above. In addition, as in the above-described example, in the disk-like liquid crystal layer 104, the single period Λ in the liquid crystal alignment pattern is 0.5 μm or less.

The cholesteric liquid crystal layer having the liquid crystal alignment pattern reflects incident light in a state where it is tilted in the arrangement axis D direction with respect to the specular reflection.

Hereinafter, the action will be described using the rod-like liquid crystal layer 102 as an example in FIG. 14. As in the above-described transmissive liquid crystal layer, the same applies to the disk-like liquid crystal layer 104.

For example, the rod-like liquid crystal layer 102 is a cholesteric liquid crystal layer that selectively reflects dextrorotatory circularly polarized light RR of red light. Accordingly, in a case where light is incident into the rod-like liquid crystal layer 102, the rod-like liquid crystal layer 102 reflects only the dextrorotatory circularly polarized light R_{R} of red light and transmits the other light.

In the rod-like liquid crystal layer 102, the optical axis 40A of the rod-like liquid crystal compound 40c changes while rotating along the arrangement axis D direction (one direction).

The liquid crystal alignment pattern formed in the rod-like liquid crystal layer 102 is a pattern that is periodic in the arrangement axis D direction. Therefore, as conceptually shown in FIG. 14, the dextrorotatory circularly polarized light R_{R} of red light incident into the rod-like liquid crystal layer 102 is diffracted in a direction corresponding to the period of the liquid crystal alignment pattern without being specularly reflected, and is reflected in a direction tilted in the arrangement axis D direction with respect to the XY plane (main surface of the cholesteric liquid crystal layer).

In the rod-like liquid crystal layer 102, by appropriately setting the direction of the arrangement axis D, which is the one direction in which the optical axis 40A changes while rotating, the diffraction direction of light, that is, the reflection direction can be adjusted.

In addition, in a case where circularly polarized light having the same wavelength and the same revolution direction is reflected, the reflection direction of the circularly polarized light can be reversed by reversing the rotation direction of the optical axis 40A of the rod-like liquid crystal compound 40c in the arrangement axis D direction.

For example, that is, in FIG. 14, the rotation direction of the optical axis 40A toward the arrangement axis D direction is clockwise, and one circularly polarized light is reflected in a state where it is tilted in the arrangement axis D direction. By setting the rotation direction of the optical axis 40A to be counterclockwise, the circularly polarized light is reflected in a state where it is tilted in a direction opposite to the arrangement axis D direction.

Further, in the liquid crystal layer having the same liquid crystal alignment pattern, the reflection direction is reversed depending on the revolution direction of the helix of the rod-like liquid crystal compound 40c, that is, the revolution direction of circularly polarized light to be reflected.

For example, in a case where the helical turning direction is right-twisted, the liquid crystal layer selectively reflects dextrorotatory circularly polarized light and has the liquid crystal alignment pattern in which the optical axis 40A rotates clockwise in the arrangement axis D direction. As a result, the dextrorotatory circularly polarized light is reflected in a state where it is tilted in the arrangement axis D direction.

In addition, for example, in a case where the revolution direction of the helix is left-handed, levorotatory circularly polarized light is selectively reflected, and the liquid crystal layer having the liquid crystal alignment pattern in which the optical axis 40A changes while rotating clockwise along the arrangement axis D direction reflects the levorotatory circularly polarized light in a state where the light is tilted in a direction opposite to the arrangement axis D direction.

Here, in the cholesteric liquid crystal layer having the liquid crystal alignment pattern in which the optical axis changes while continuously rotating along at least one direction, as the single period Λ decreases, the diffraction angle of reflected light increases. For example, in a case where light is incident into the cholesteric liquid crystal layer from the normal direction, as the single period Λ decreases, the angle between the reflected light and the normal direction, which is specular reflection, increases. Here, as described above, in the optical element according to the embodiment of the present invention, both the rod-like liquid crystal layer 102 and the disk-like liquid crystal layer 104 have a single period Λ of less than 0.5 μm.

Further, in the optical element according to the embodiment of the present invention, as in the transmission-type optical element, the rod-like liquid crystal layer having a cholesteric alignment and the disk-like liquid crystal layer having a cholesteric alignment, which have the same liquid crystal alignment pattern, are laminated. As a result, incident light can be reflected with high diffraction efficiency.

Accordingly, with the reflective optical element according to the embodiment of the present invention, incident light can be reflected with high diffraction efficiency and a large diffraction angle.

Both the rod-like liquid crystal layer 102 and the disk-like liquid crystal layer 104 shown in FIGS. 13 and 14 have the liquid crystal alignment pattern in which the optical axis derived from the liquid crystal compound changes while continuously rotating along the one direction as shown in FIGS. 4 to 7. However, the reflective optical element according to the embodiment of the present invention is not limited thereto.

That is, in the reflective optical element according to the embodiment of the present invention, the rod-like liquid crystal layer and the disk-like liquid crystal layer may have a concentric liquid crystal alignment pattern as shown in FIG. 11.

Here, in the cholesteric liquid crystal layer having the concentric liquid crystal alignment pattern as shown in FIG. 11, directions of arrows D₁, D₂, . . . from the center toward the outer side correspond to the arrangement axis D in FIG. 5 and the like, and the direction of each of the concentric circles corresponds to the arrow Y direction in FIG. 5 and the like.

Accordingly, the reflective optical element according to the embodiment of the present invention using the rod-like liquid crystal layer and the disk-like liquid crystal layer, which are the cholesteric liquid crystal layers having the concentric liquid crystal alignment pattern, act as a concave mirror that collects light or a convex mirror that diffuses light depending on the revolution direction of circularly polarized light to be incident.

The reflective rod-like liquid crystal layer 102 and the disk-like liquid crystal layer 104, which are the cholesteric liquid crystal layers in which the liquid crystal compound is cholesterically aligned, can be basically formed in the same manner as the above-described transmission liquid crystal layer in which the liquid crystal compound is twisted and aligned by 360° or less in the thickness direction.

However, since the reflective rod-like liquid crystal layer 102 and the disk-like liquid crystal layer 104 are formed of the liquid crystal compound that is cholesterically aligned, it is necessary to increase the addition amount of the chiral agent in the liquid crystal composition forming the liquid crystal layer as compared with the transmission liquid crystal layer.

The reflective optical element according to the embodiment of the present invention is not limited to the configuration in which one rod-like liquid crystal layer 102 and one disk-like liquid crystal layer 104 are provided.

For example, the optical element according to the embodiment of the present invention may include six liquid crystal layers of a rod-like liquid crystal layer and a disk-like liquid crystal layer that selectively reflect red light, a rod-like liquid crystal layer and a disk-like liquid crystal layer that selectively reflect green light, and a rod-like liquid crystal layer and a disk-like liquid crystal layer that selectively reflect blue light. Alternatively, the optical element according to the embodiment of the present invention may include four liquid crystal layers of a rod-like liquid crystal layer and a disk-like liquid crystal layer that selectively reflect red light, and a rod-like liquid crystal layer and a disk-like liquid crystal layer that selectively reflect blue light.

Further, the optical element according to the embodiment of the present invention may include a rod-like liquid crystal layer and a disk-like liquid crystal layer that selectively reflect dextrorotatory circularly polarized light and a rod-like liquid crystal layer and a disk-like liquid crystal layer that selectively reflect levorotatory circularly polarized light, which selectively reflect light of the same color.

In the reflective optical element according to the embodiment of the present invention, it is preferable that a combination of one rod-like liquid crystal layer and one disk-like liquid crystal layer has the same liquid crystal alignment pattern as the above-described transmission optical element and selectively reflects circularly polarized light of the same color and the same revolution direction. The combination of one rod-like liquid crystal layer and one disk-like liquid crystal layer is not limited thereto, and the liquid crystal alignment pattern and the revolution direction of circularly polarized light to be selectively reflected can be appropriately set depending on the purpose.

In the reflective optical element according to the embodiment of the present invention, the thicknesses of the rod-like liquid crystal layer 102 and the disk-like liquid crystal layer 104, which are the cholesteric liquid crystal layers, are not limited.

That is, the thicknesses of the rod-like liquid crystal layer 102 and the disk-like liquid crystal layer 104 may be appropriately set depending on the wavelength range to be selectively reflected, the liquid crystal compound, the chiral agent, and the like to be used, to achieve a desired reflectivity.

The optical element according to the embodiment of the present invention can be used in various optical devices and optical systems such as a beam steering device, structured light, hyperspectral sensing, a diffraction element for AR glasses, a diffraction element for VR goggles, and a diffractive lens.

Among these, the optical element according to the embodiment of the present invention is suitably used for a head-mounted display (HMD) such as AR glasses and VR goggles.

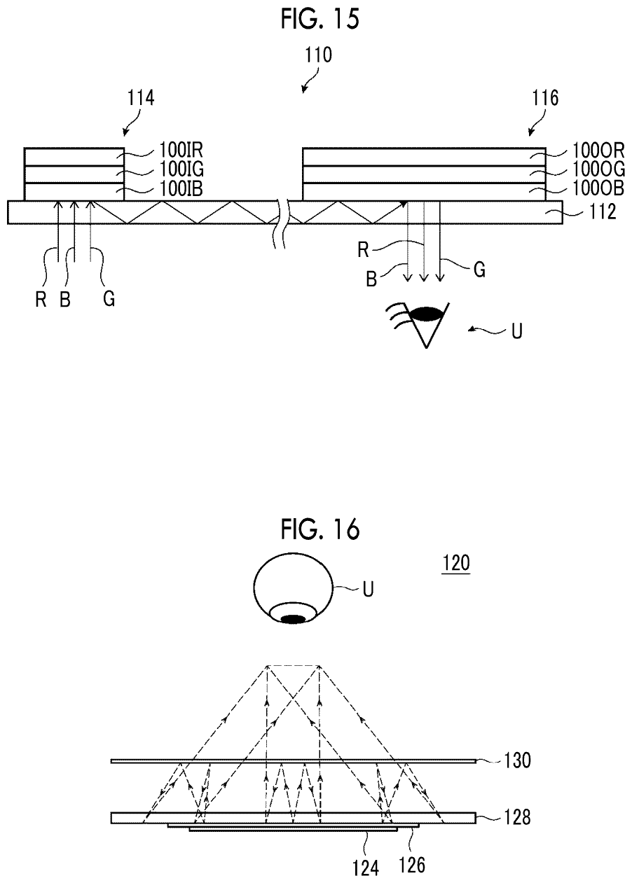

FIG. 15 conceptually shows an example of AR glasses using the reflective optical element according to the embodiment of the present invention.

An AR glasses 110 shown in FIG. 15 includes a light guide plate 112, an incidence unit 114, and an emission unit 116.

The incidence unit 114 includes an optical element 100IR according to the embodiment of the present invention that selectively reflects red light R (red image), an optical element 100IG according to the embodiment of the present invention that selectively reflects green light G (green image), and an optical element 100IB according to the embodiment of the present invention that selectively reflects blue light B (blue image).

The emission unit 116 includes an optical element 100OR according to the embodiment of the present invention that selectively reflects red light R, an optical element 1000G according to the embodiment of the present invention that selectively reflects green light G, and an optical element 100OB according to the embodiment of the present invention that selectively reflects blue light B.

The AR glasses 110 using the optical element according to the embodiment of the present invention is not limited thereto, and may include only an optical element corresponding to one color or an optical element corresponding to two colors.

The optical element 100IR, the optical element 100IG, and the optical element 100IB of the incidence unit 114 and the optical element 100OR, the optical element 1000G, and the optical element 100OB of the emission unit 116 are basically the same as the reflective optical element 100 according to the embodiment of the present invention shown in FIG. 13 except that the wavelengths of light to be selectively reflected are different.

That is, as shown in FIGS. 4 to 7, the rod-like liquid crystal layer and the disk-like liquid crystal layer forming these optical elements have a liquid crystal alignment pattern in which the optical axis of the liquid crystal compound changes while continuously rotating in one direction.

Accordingly, each optical element diffracts and reflects incident light to be tilted in a predetermined direction.

The AR glasses 110 shown in FIG. 1 is basically the same as known AR glasses, that is, a display device for an augmented reality image, except that the optical element according to the embodiment of the present invention is used as an optical element for emitting light to and from the light guide plate 112 in the incidence unit 114 and the emission unit 116.

Accordingly, the AR glasses 110 may include various optical elements (optical members) included in known AR glasses in addition to the members shown in the drawing.

In the AR glasses 110, in an image displayed (emitted) by an image display element (display) (not shown), red light R is diffracted and reflected by the optical element 100IR, green light G is diffracted and reflected by the optical element 100IG, and blue light B is reflected by the optical element 100IB, and all of these are incident into the light guide plate 112 at an angle of total reflection.

Each image propagates in the light guide plate 112 by being totally reflected, red light R is diffracted and reflected by the optical element 1000R, green light G is diffracted and reflected by the optical element 1000G, and blue light B is reflected by the optical element 1000B, and all of these are emitted from the light guide plate 112.

The red light R, the green light G, and the blue light B emitted from the light guide plate 112, that is, the augmented reality image are observed by the user U of the AR glasses together with the background.

Here, in order to reduce the thickness and size of the AR glasses, it is preferable that the light guide plate 112 is as thin as possible. In order to allow light to be incident into the thin light guide plate 112 at an angle of total reflection and to allow the light to be emitted from the light guide plate 112, it is necessary to diffract the light at a large diffraction angle in the incidence unit 114 and the emission unit 116.

On the other hand, as described above, in the optical element according to the embodiment of the present invention, the single period Λ in the liquid crystal alignment patterns of the rod-like liquid crystal layer and the disk-like liquid crystal layer is 0.5 μm or less, and incident light can be reflected at a large diffraction angle.

In addition, as described above, the optical element according to the embodiment of the present invention is obtained by laminating the rod-like liquid crystal layer and the disk-like liquid crystal layer, and has a high diffraction efficiency.

Accordingly, by using the optical element according to the embodiment of the present invention in the AR glasses, the AR glasses can be reduced in thickness and size, and the augmented reality image having high brightness can be displayed by using the image (light) displayed by the image display element without waste.

FIG. 16 conceptually shows an example of VR goggles using the reflective type optical element according to the embodiment of the present invention.

VR goggles 120 shown in FIG. 16 include an image display element 124, a circular polarizer 126, the optical element 128 according to the embodiment of the present invention, and a half mirror 130.

The VR goggles shown in FIG. 16 are basically the same as known VR goggles having a folded-back optical system, that is, a virtual reality image display device, except that the reflective type optical element according to the embodiment of the present invention is used in the folded-back optical system. Accordingly, the VR goggles 120 may include various optical elements, such as a known absorption type circular polarizer for removing unnecessary circularly polarized light that is incident into the half mirror 130 and transmitted first, as necessary.

The optical element 128 is the reflective type optical element according to the embodiment of the present invention, and is obtained by laminating a rod-like liquid crystal layer in which a rod-like liquid crystal compound 40c is cholesterically aligned and a disk-like liquid crystal layer in which a disk-like liquid crystal compound 40d is cholesterically aligned, as in the optical element 100 according to the embodiment of the present invention shown in FIG. 13.

Here, in the optical element 128, each liquid crystal layer has the concentric liquid crystal alignment pattern shown in FIG. 11. Accordingly, the optical element 128 collects or diverges circularly polarized light in one revolution direction, reflects the circularly polarized light, and transmits circularly polarized light in the other revolution direction.

In the example shown in the drawing, as an example, the optical element 128 is obtained by laminating a rod-like liquid crystal layer and a disk-like liquid crystal layer, which are cholesteric liquid crystal layers that diffract and reflect levorotatory circularly polarized light to selectively collect the levorotatory circularly polarized light, and acts as a concave mirror with respect to the levorotatory circularly polarized light.

In the VR goggles 120 of FIG. 16, only one optical element 128 is shown in order to simplify the drawing.

However, the present invention is not limited to this, and as in the above-described AR glasses, the VR goggles 120 may include a plurality of optical elements according to the embodiment of the present invention, such as three optical elements 128 that selectively reflect red light, green light, and blue light, as necessary.

In the VR goggles 120, an image displayed by the image display element 124 is converted into dextrorotatory circularly polarized light by the circular polarizer 126 consisting of, for example, a linear polarizer and a λ/4 retardation plate, and is incident into the optical element 128.

As described above, the optical element 128 consists of a rod-like liquid crystal layer and a disk-like liquid crystal layer, which are cholesteric liquid crystal layers that selectively reflect levorotatory circularly polarized light. Therefore, dextrorotatory circularly polarized light transmits through the optical element 128.

The dextrorotatory circularly polarized light transmitted through the optical element 128 is incident into the half mirror 130, and half of the dextrorotatory circularly polarized light is reflected. The reflection converts the dextrorotatory circularly polarized light into levorotatory circularly polarized light.

The levorotatory circularly polarized light reflected by the half mirror 130 is incident into the optical element 128 again. As described above, the optical element 128 diffracts and reflects the levorotatory circularly polarized light to selectively collect the levorotatory circularly polarized light. Accordingly, the levorotatory circularly polarized light incident into the optical element 128 is reflected to be collected.

Half of the levorotatory circularly polarized light reflected by the optical element 128 transmits through the half mirror 130 and is observed by the user U of the VR goggles as a VR image (virtual reality image).

Here, in order to reduce the thickness and size of the VR goggles 120, it is necessary to collect an image by diffracting reflected light by the optical element 128 to a large extent such that the focal length of the optical system is shortened.

On the other hand, as described above, in the optical element 128 according to the embodiment of the present invention, the single period Λ in the liquid crystal alignment patterns of the rod-like liquid crystal layer and the disk-like liquid crystal layer is 0.5 μm or less, and incident light can be reflected at a large diffraction angle.

In addition, as described above, the optical element according to the embodiment of the present invention is obtained by laminating the rod-like liquid crystal layer and the disk-like liquid crystal layer, and has a high diffraction efficiency.

Accordingly, by using the optical element according to the embodiment of the present invention for the VR goggles, the VR goggles can be reduced in thickness and size, and an AR image (augmented reality image) having high brightness can be displayed by using the image (light) displayed by the image display element 124 without waste.

In addition, in the VR goggles 120, it is also considered to use a half mirror instead of the optical element 128 according to the embodiment of the present invention. However, in a case where a half mirror or the like that reflects light at a large angle is used, a half mirror having a large curvature is required, and the VR goggles are increased in size accordingly. On the other hand, the optical element 128 according to the embodiment of the present invention has a sheet shape, and a large disposition space is not required. In this respect as well, the thickness and size of the VR goggles 120 can be reduced.

In the above-described example, the reflective type optical element according to the embodiment of the present invention is used for the HUD. However, the transmissive type optical element according to the embodiment of the present invention is also suitably used for the HUD.

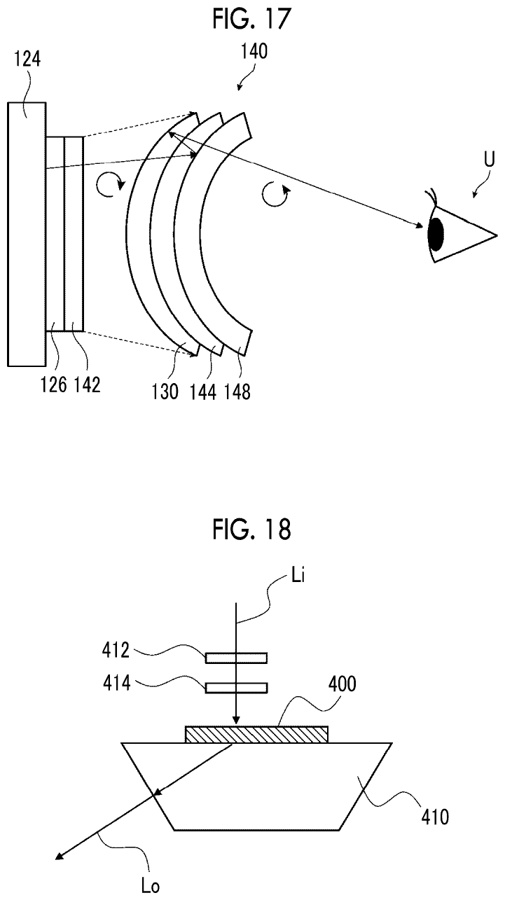

FIG. 17 conceptually shows an example of the VR goggles using the transmissive type optical element according to the embodiment of the present invention.

In the VR goggles 140 shown in FIG. 17, the same members as those of the VR goggles 120 shown in FIG. 16 are used in plurality. Therefore, the same members are denoted by the same reference numerals.

The VR goggles 140 shown in FIG. 17 include the image display element 124, the circular polarizer 126, the optical element 142 according to the embodiment of the present invention, the half mirror 130, a lens 144, and the reflective circular polarizer 146.

The VR goggles 140 shown in FIG. 17 is basically the same as the known VR goggles having a folded-back optical system, that is, the virtual reality image display apparatus, except that the reflective type optical element according to the embodiment of the present invention is used in the folded-back optical system. Therefore, the VR goggles 140 may include various optical elements, such as a circular polarizer for shielding dextrorotatory circularly polarized light that is transmitted through the reflective circular polarizer 146, which is provided downstream of the reflective circular polarizer 146, as necessary.

The optical element 142 is the transmissive type optical element according to the embodiment of the present invention, and is formed by laminating a rod-like liquid crystal layer consisting of a rod-like liquid crystal compound 40c and a disk-like liquid crystal layer consisting of a disk-like liquid crystal compound 40d, as in the optical element 10 according to the embodiment of the present invention shown in FIG. 1.

Here, in the optical element 142, each liquid crystal layer has the concentric liquid crystal alignment pattern shown in FIG. 11. Accordingly, the optical element 142 collects and transmits circularly polarized light in one revolution direction and diverges and transmits circularly polarized light in the other revolution direction.

In the example shown in the drawing, as an example, the optical element 142 is formed by laminating a rod-like liquid crystal layer and a disk-like liquid crystal layer that diverge dextrorotatory circularly polarized light, and acts as a concave lens with respect to the dextrorotatory circularly polarized light.

In the VR goggles 140, the image displayed by the image display element 124 is converted into dextrorotatory circularly polarized light by the circular polarizer 126 as described above, and is incident into the optical element 142.

As described above, the optical element 142 consists of a rod-like liquid crystal layer and a disk-like liquid crystal layer that diverge dextrorotatory circularly polarized light. Accordingly, the dextrorotatory circularly polarized light incident into the optical element 142 is emitted after being diverged as indicated by a broken Iine in the drawing.

In the VR goggles 140 in the example shown in the drawing, the optical element 142 that emits light is provided between the half mirror 130 and the image display element 124, and thus directivity can be imparted to the light (image) emitted from the image display element 124 depending on the in-plane position. As a result, the brightness of the end part side of the displayed virtual reality image can be improved, and the brightness distribution of the virtual reality image can be made uniform.

The dextrorotatory circularly polarized light transmitted through the optical element 142 is incident into the half mirror 130, half of the light is transmitted through the half mirror 130, and the transmitted light is transmitted through the lens 144 and is incident into the reflective circular polarizer 146.

The reflective circular polarizer 146 is a reflective type circular polarizer that reflects dextrorotatory circularly polarized light and transmits levorotatory circularly polarized light. Accordingly, the dextrorotatory circularly polarized light incident into the reflective circular polarizer 146 is reflected by the reflective circular polarizer 146.

The dextrorotatory circularly polarized light reflected by the reflective circular polarizer 146 is transmitted through the lens 144 again, is incident into the half mirror 130, and is reflected by the half mirror 130. The dextrorotatory circularly polarized light is reflected by the half mirror 130 and is converted into levorotatory circularly polarized light.

The levorotatory circularly polarized light reflected by the half mirror 130 is transmitted through the lens 144 again, is collected, and is incident into the reflective circular polarizer 146. As described above, the reflective circular polarizer 146 reflects dextrorotatory circularly polarized light and transmits levorotatory circularly polarized light, and thus the levorotatory circularly polarized light is transmitted through the reflective circular polarizer 146 and is observed by the user U of the VR goggles 140 as the virtual reality image.

Here, in order to reduce the thickness and size of the VR goggles 140, it is necessary to diffract the reflected light by the optical element 142 to a large extent and to diffuse the image.

On the other hand, as described above, in the optical element 142 according to the embodiment of the present invention, the single period Λ in the liquid crystal alignment patterns of the rod-like liquid crystal layer and the disk-like liquid crystal layer is 0.5 μm or less, and the incident light can be diffused and transmitted at a large diffraction angle.

In addition, as described above, the optical element according to the embodiment of the present invention is obtained by laminating the rod-like liquid crystal layer and the disk-like liquid crystal layer, and has a high diffraction efficiency.

Accordingly, by using the optical element according to the embodiment of the present invention for the VR goggles, the VR goggles can be reduced in thickness and size, and an AR image (augmented reality image) having high brightness can be displayed by using the image (light) displayed by the image display element 124 without waste.

In addition, in the VR goggles, it is also considered to use a concave lens instead of the optical element 142 according to the embodiment of the present invention. However, in a case where a concave lens that diffuses light at a large angle is used, a thick concave lens having a large curvature is required, and the VR goggles are large accordingly. On the other hand, the optical element 142 according to the embodiment of the present invention has a sheet shape, and a large disposition space is not required, and thus the thickness and size of the VR goggles 140 can be reduced.

Although the optical element according to the embodiment of the present invention has been described in detail above, the present invention is not limited to the above-described examples, and various improvements, modifications, and the like may be made within a range not departing from the scope of the present invention.

### EXAMPLES

The features of the present invention will be described in more detail with reference to the following examples.

The materials, the reagents, the amounts, the amounts of materials, the proportions, the treatment details, the treatment procedures, and the like shown in Examples below can be appropriately modified within a range not departing from the spirit of the present invention. Therefore, the scope of the present invention should not be construed as being limited by the specific examples described below.

### Comparative Example 1

An alignment film was formed on a support, and an optically anisotropic layer A-1 (rod-like liquid crystal layer) consisting of a cured layer of a liquid crystal composition D1 including a rod-like liquid crystal compound was formed on the alignment film to produce an optical element of Comparative Example 1. The optically anisotropic layer A-1 had a liquid crystal alignment pattern in which the rod-like liquid crystal compound rotated and was aligned horizontally.

### [Preparation of Optical Element of Comparative Example 1]

A glass substrate was used as a support.

### (Formation of Alignment Film P-1)

The support (glass substrate) was continuously coated with the following coating liquid for forming an alignment film P-1 using a #2 wire bar. The support on which the coating film formed of the coating liquid for forming the alignment film P-1 was formed was dried with hot air at 60° C. for 60 seconds, thereby forming an alignment film P-1.

<Coating Liquid for Forming Alignment Film p-1>

| | |
|---|---|
| The following material for photo-alignment | 1.00 part by mass |
| Water | 16.00 parts by mass |
| Butoxyethanol | 42.00 parts by mass |
| Propylene glycol monomethyl ether | 42.00 parts by mass |

-Material for photo alignment-

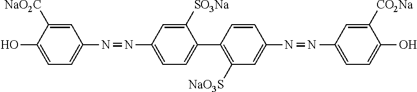

### (Exposure of Alignment Film P-1)

The alignment film was exposed using the exposure device 60 illustrated in FIG. 8. In the exposure device 60, a laser that emits laser light having a wavelength (355 nm) was used as the laser 52. The exposure amount of the interference light was 1000 mJ/cm².

In the exposure device 60, the intersecting angle α between the two rays MA and MB was adjusted such that the single period Λ of the alignment pattern formed by the interference of the two laser beams, that is, the period over which the optical axis of the liquid crystal compound rotated by 180° was 0.4 μm.

### (Formation of Optically Anisotropic Layer A-1)

First, the following liquid crystal composition D1 was prepared.

### <Liquid Crystal Composition D1>

| | |
|---|---|
| Rod-like liquid crystal compound L-1 | 100.00 parts by mass |
| Polymerization initiator (IRGACURE (registered trade name) 907, manufactured by BASF SE) | 3.00 parts by mass |
| Photosensitizer (KAYACURE DETX-S, manufactured by Nippon Kayaku Co., Ltd.) | 1.00 part by mass |
| Leveling agent T-1 | 0.50 parts by mass |
| Methyl ethyl ketone | 2,500.00 parts by mass |

-Rod-like liquid crystal compound L-1- 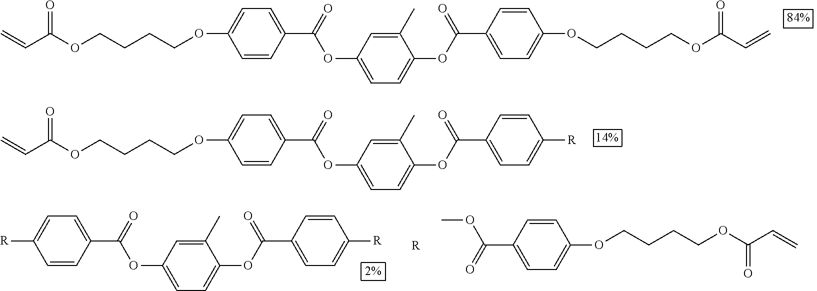
-Leveling agent T-1-

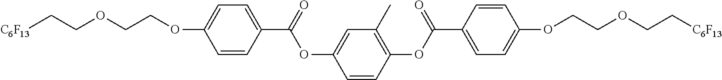

Further, the complex refractive index Δn of the cured layer of the liquid crystal composition D1 was 0.15. The complex refractive index Δn was acquired by measuring the retardation value and the film thickness of the liquid crystal immobilization layer (cured layer) obtained by coating a support provided with an alignment film for measuring the retardation which was separately provided with the liquid crystal composition D1, aligning the optical axis of the rod-like liquid crystal compound to be horizontal to the substrate, and performing irradiation with ultraviolet rays for immobilization. Further, the complex refractive index Δn can be calculated by dividing the retardation value by the film thickness.

The retardation value was measured at a wavelength of 550 nm using Axoscan (manufactured by Axometrix Inc.), and the film thickness was measured using a scanning electron microscope (SEM).

### <Formation of Coating of Optically Anisotropic Layer A-1>

An optically anisotropic layer A-1 was formed by multilayer-coating the alignment film P-1 with the following liquid crystal composition D1.

The multilayer-coating was performed by coating the alignment film with the first liquid crystal composition D1, heating the composition, cooling the composition, and curing the composition with ultraviolet rays to prepare the liquid crystal immobilization layer. The second and subsequent liquid crystal immobilization layers were obtained by repeating the processes of coating the liquid crystal immobilization layer with the composition through overcoating, heating the composition, cooling the composition, and curing the composition using ultraviolet rays. By forming the optically anisotropic layer through multilayer-coating, the alignment direction of the alignment film can be reflected from the lower surface to the upper surface of the liquid crystal layer even in a case where the total thickness of the liquid crystal layer increases.

First, as the first layer, the coating film obtained by coating the alignment film P-1 with the following liquid crystal composition D1 was heated on a hot plate at 110° C. and then cooled to 60° C., and the coating film was irradiated with ultraviolet rays having a wavelength of 365 nm at an irradiation dose of 300 mJ/cm² using a high pressure mercury lamp in a nitrogen atmosphere, thereby immobilizing the alignment of the liquid crystal compound. The film thickness of the immobilized liquid crystal layer (one liquid crystal immobilized layer) at this time was 0.15 μm.

The second and subsequent liquid crystal immobilization layers were formed by coating the previously formed liquid crystal immobilization layer with the liquid crystal composition D1 through overcoating, heating and cooling the composition under the same conditions as described above, and then curing the composition using ultraviolet rays. In this manner, an optically anisotropic layer A-1 was obtained by repeating the overcoating until the total thickness reached a desired film thickness. Finally, it was confirmed that the birefringence index of the liquid crystal was 275 nm (=λ/2) and the surface was periodically aligned using a polarizing microscope.

### Comparative Example 2

An optical element comprising an optically anisotropic layer A-2 (disk-like liquid crystal layer) consisting of a cured layer of a liquid crystal composition E1 including a disk-like liquid crystal compound instead of the rod-like liquid crystal compound was obtained as in Comparative Example 1. That is, the optical element of Comparative Example 2 had a liquid crystal alignment pattern in which the disk-like liquid crystal compound rotated and was aligned horizontally.

### (Formation of Optically Anisotropic Layer A-2)

A liquid crystal composition E1 with the following composition was prepared.

### <Liquid Crystal Composition E1>

| | |
|---|---|
| Disk-like liquid crystal compound L-2 | 80.00 parts by mass |
| Disk-like liquid crystal compound L-3 | 20.00 parts by mass |
| Polymerization initiator (Irgacure (registered trade name) 907, manufactured | 5.00 parts by mass |
| by BASF SE) | |
| MEGAFACE F444 (manufactured by DIC Corporation) | 0.50 parts by mass |
| Methyl ethyl ketone | 2,500.00 parts by mass |

-Disk-Like Liquid Crystal Compound L-2- 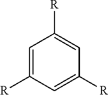
R = 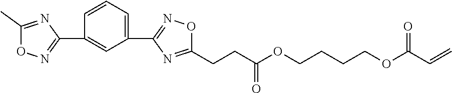 [SMILES: C=CC(=O)OCCCCOC(=O)CCc1nc(-c2cccc(-c3noc(C)n3)c2)no1]
-Disk-Like Liquid Crystal Compound L-3- 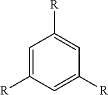
R =

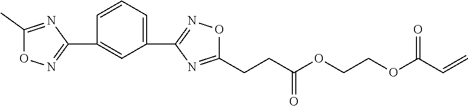 [SMILES: C=CC(=O)OCCOC(=O)CCc1nc(-c2cccc(-c3noc(C)n3)c2)no1]

The complex refractive index Δn of the cured layer of the liquid crystal composition E1 was 0.15. The complex refractive index Δn was acquired according to the same method as in the case of the liquid crystal composition D1.

### <Formation of Coating of Optically Anisotropic Layer A-2>

First, as the first layer, the coating film obtained by coating the alignment film P-1 with the above-described liquid crystal composition E1 was heated on a hot plate at 110° C. and then cooled to 60° C., and the coating film was irradiated with ultraviolet rays having a wavelength of 365 nm at an irradiation dose of 300 mJ/cm² using a high pressure mercury lamp in a nitrogen atmosphere, thereby immobilizing the alignment of the liquid crystal compound. The film thickness of the immobilized liquid crystal layer (one liquid crystal immobilized layer) at this time was 0.15 μm.

The second and subsequent liquid crystal immobilization layers were formed by coating the previously formed liquid crystal immobilization layer with the liquid crystal composition E1 through overcoating, heating and cooling the composition under the same conditions as described above, and then curing the composition using ultraviolet rays. In this manner, an optically anisotropic layer A-2 was obtained by repeating the overcoating until the total thickness reached a desired film thickness. Finally, it was confirmed that the birefringence index of the liquid crystal was 275 nm (=λ/2) and the surface was periodically aligned using a polarizing microscope.

### Example 1

First, an alignment film was formed on a support, and an optically anisotropic layer A-1 (rod-like liquid crystal layer) consisting of a cured layer of a liquid crystal composition D₁ including a rod-like liquid crystal compound was formed on the alignment film. Thereafter, an optically anisotropic layer A-2 (disk-like liquid crystal layer) consisting of a cured layer of the liquid crystal composition E1 including a disk-like liquid crystal compound was formed to prepare an optical element of Example 1. Hereinafter, the optically anisotropic layer A-1 (rod-like liquid crystal layer) in the present example will be referred to as “first optically anisotropic layer A-1”, and the optically anisotropic layer A-2 (disk-like liquid crystal layer) will be referred to as “second optically anisotropic layer A-2”.

That is, the optical element had a two-layer structure of the first optically anisotropic layer A-1 formed of a cured layer of a liquid crystal composition D1 containing a rod-like liquid crystal compound as the first layer and the second optically anisotropic layer A-2 formed of a cured layer of a liquid crystal composition E1 containing a disk-like liquid crystal compound as the second layer.

The optical element of Example 1 was obtained by forming the alignment film on the support and forming the first optically anisotropic layer A-1 on the alignment film in the same manner as in Comparative Example 1 and then forming the optically anisotropic layer A-2 on the first optically anisotropic layer A-1 in the same manner as that for the second optically anisotropic layer A-2 formed on the alignment film in Comparative Example 2. In this case, the coating amount of each of the optically anisotropic layers A-1 and A-2 was adjusted such that the in-plane retardation And (=Δn₁d₁+Δn₂d₂) in the entire laminated structure was 275 nm, and the optical element was prepared in the same manner as in Comparative Example 1 and Comparative Example 2, except for this adjustment.

Here, Δn₁ represents the birefringence index of the first optically anisotropic layer, d₁ represents the thickness of the first optically anisotropic layer, Δn₂ represents the birefringence index of the second optically anisotropic layer, and d₂ represents the thickness of the second optically anisotropic layer.

Δn₁ and Δn₂ were both 0.15. The complex refractive index Δn was acquired according to the same method as in the case of the liquid crystal composition D₁.

It was confirmed that two layers of the liquid crystal alignment patterns having horizontal rotational alignment were laminated on each other based on the cross section SEM image of the optical element of Example 1. Further, it was confirmed that the first optically anisotropic layer which was the first layer had alignment of rod-like liquid crystal compound, and the second optically anisotropic layer which was the second layer had alignment of the disk-like liquid crystal compound, as measured by Axoscan (manufactured by Axometrix, Inc.).

The prepared optical element had a configuration in which two layers were laminated, the in-plane retardation Δn₁d₁ of the first optically anisotropic layer was 138 nm and the twisted angle was 0 degrees, and the in-plane retardation Δn₂d₂ of the second optically anisotropic layer was 137 nm and the twisted angle was 0 degrees.

### Example 2

First, the following liquid crystal composition D₂ was prepared.

### <Liquid Crystal Composition D₂>

| | |
|---|---|
| Rod-like liquid crystal compound L-1 | 100.00 parts by mass |
| Polymerization initiator (IRGACURE | 3.00 parts by mass |
| (registered trade name) | |
| 907, manufactured by BASF SE) | |
| Photosensitizer (KAYACURE DETX-S, | 1.00 part by mass |
| manufactured by Nippon Kayaku Co., Ltd.) | |
| Leveling agent T-1 | 0.50 parts by mass |
| Chiral agent Ch-2 | 0.12 parts by mass |
| Methyl ethyl ketone | 2,500.00 parts by mass |

-Chiral agent Ch-2-

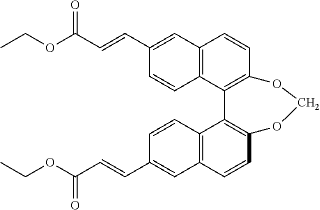

A liquid crystal composition E2 with the following composition was prepared.

### <Liquid Crystal Composition E2>

| | |
|---|---|
| Disk-like liquid crystal compound L-2 | 80.00 parts by mass |
| Disk-like liquid crystal compound L-3 | 20.00 parts by mass |
| Polymerization initiator (Irgacure | 5.00 parts by mass |
| (registered trade name) | |
| 907, manufactured by BASF SE) | |
| MEGAFACE F444 (manufactured by DIC | 0.50 parts by mass |
| Corporation) | |
| Chiral agent Ch-2 | 0.14 parts by mass |
| Methyl ethyl ketone | 2,500.00 parts by mass |

First, an alignment film was formed on a support, and an optically anisotropic layer A2-1 (rod-like liquid crystal layer) consisting of a cured layer of a liquid crystal composition D2 including a rod-like liquid crystal compound was formed on the alignment film. Thereafter, an optically anisotropic layer A2-2 (disk-like liquid crystal layer) consisting of a cured layer of a liquid crystal composition E2 including a disk-like liquid crystal compound was formed to manufacture an optical element of Example 2. Hereinafter, the optically anisotropic layer A2-1 (rod-like liquid crystal layer) in the present example will be referred to as “first optically anisotropic layer A2-1”, and the optically anisotropic layer A2-2 (disk-like liquid crystal layer) will be referred to as “second optically anisotropic layer A2-2”.

That is, a two-layer structure where the first layer was the first optically anisotropic layer A2-1 consisting of the cured layer of the liquid crystal composition D2 including the rod-like liquid crystal compound and the second layer was the second optically anisotropic layer A2-2 consisting of the cured layer of the liquid crystal composition E2 including the disk-like liquid crystal compound was formed.

In the optical element of Example 2, an alignment film was formed on a support in the same manner as in Example 1, the first optically anisotropic layer A2-1 was formed on the alignment film, and then the second optically anisotropic layer A2-2 was formed on the first optically anisotropic layer A2-1 in the same manner as in Example 1. Here, the coating amount of each of the optically anisotropic layers A2-1 and A2-2 was adjusted such that the in-plane retardation Δnd (=Δn₁d₁+Δn₂d₂) in the entire laminated structure was 275 nm, and the optical element was manufactured in the same manner as in Example 1 except for this.

Here, Δn₁ represents the birefringence index of the first optically anisotropic layer, d₁ represents the thickness of the first optically anisotropic layer, Δn₂ represents the birefringence index of the second optically anisotropic layer, and d₂ represents the thickness of the second optically anisotropic layer.

Δn₁ and Δn₂ were both 0.15. The complex refractive index Δn was acquired according to the same method as in the case of the liquid crystal composition D₁.

It was confirmed that two layers of the liquid crystal alignment patterns having horizontal rotational alignment were laminated on each other based on the cross section SEM image of the optical element of Example 2. Further, it was confirmed that the first optically anisotropic layer which was the first layer had alignment of rod-like liquid crystal compound, and the second optically anisotropic layer which was the second layer had alignment of the disk-like liquid crystal compound, as measured by Axoscan (manufactured by Axometrix, Inc.).

The manufactured optical element had a configuration in which two layers were laminated, in which the first optically anisotropic layer had an in-plane retardation Δn₁ d₁ of 138 nm and a twisted angle of 37 degrees, and the second optically anisotropic layer had an in-plane retardation Δn2d₂ of 137 nm and a twisted angle of 37 degrees.

### [Evaluation]

The intensity of diffracted light diffracted by the optical element manufactured in each example was measured by the following method to measure the diffraction efficiency of each optical element.

As shown in FIG. 18, the manufactured optical element 400 was disposed on the surface (upper surface in the drawing) of a dove prism 410. As the dove prism 410, a dove prism formed of glass having a refractive index of 1.5 was used. The optical element 400 was bonded to the dove prism 410 using a thermosensitive adhesive by peeling off the support (glass substrate).

As shown in FIG. 18, a laser light source (not shown) was disposed at a position facing the optical element 400 disposed on the upper surface of the dove prism 410. Further, a linear polarizer 412 and a λ/4 plate 414 were disposed between the laser light source and the dove prism 410.

Laser light Li emitted from the laser light source was passed through the linear polarizer 412 and the λ/4 plate 414 to be incident into the optical element 400 disposed on the upper surface of the dove prism 410 as circularly polarized light.

The laser light Li incident into the optical element 400 (optically anisotropic layer) was diffracted by the optical element 400 as described above, propagated in the dove prism 410, and was emitted from the dove prism 410.

The wavelength of the laser light Li was 532 nm. In addition, the angle of the laser light source was set such that the laser light Li was incident into the main surface of the optical element 400 at 0° with respect to the normal direction. That is, the laser light Li was incident into the optical element 400 from the normal direction of the main surface of the optical element 400.

The laser light Li was incident into the optical element 400, and the intensity of emitted light Lo emitted from the dove prism 410 by being diffracted in a desired direction (a direction of an oblique surface of the dove prism 410) oblique to the normal direction of the main surface of the optical element 400 by the optical element 400 was measured.

In a case where the intensity of the laser light Li incident into the dove prism 410 is denoted by Iᵢₙ and the intensity of diffracted light (first-order light) diffracted in the desired direction by the optical element 400 and emitted from the dove prism 410, that is, the intensity of the emitted light Lo is denoted by Iₒᵤₜ, the diffraction efficiency Deff of the manufactured optical element 400 was calculated by the following expression.

$$Diffraction efficiency Deff = {I}_{out} / {I}_{i n}$$

The diffraction efficiency was calculated by excluding the loss of the transmittance at the interface during the incidence into the dove prism 410 and during the emission from the dove prism 410.

As a result, in the optical elements manufactured in Example 1 and Example 2, a high diffraction efficiency was obtained at a wavelength of 532 nm as compared with Comparative Example 1 and Comparative Example 2. In addition, in the optical element manufactured in Example 2, a high diffraction efficiency was obtained at a wavelength of 532 nm as compared with Example 1.

### Comparative Example 11

An alignment film was formed on the support in the same manner as in Comparative Example 1. An optically anisotropic layer C-1 (rod-like liquid crystal layer) consisting of a cured layer of a liquid crystal composition DC1 including a rod-like liquid crystal compound was formed on the alignment film to produce an optical element of Comparative Example 11. The optically anisotropic layer C-1 had a liquid crystal alignment pattern in which the rod-like liquid crystal compound was horizontally rotationally aligned and a cholesteric phase was provided in the thickness direction.

### [Preparation of Optical Element of Comparative Example 11]

An optical element of Comparative Example 11 was prepared in the same manner as in Comparative Example 1 except that an optically anisotropic layer having a liquid crystal alignment pattern with a cholesteric phase was formed using the liquid crystal composition D1 as the liquid crystal composition DC1. From a cross-sectional SEM of the optical element, it was confirmed that the liquid crystal alignment pattern had a cholesteric phase.

### (Formation of Optically Anisotropic Layer C-1)

A liquid crystal composition DC1 with the following composition was prepared.

### <Liquid Crystal Composition DC1>

| | |
|---|---|
| Rod-like liquid crystal compound L-1 | 100.00 parts by mass |
| Polymerization initiator (IRGACURE (registered trade name) 907, manufactured by BASF SE) | 3.00 parts by mass |
| Photosensitizer (KAYACURE DETX-S, manufactured by Nippon Kayaku Co., Ltd.) | 1.00 part by mass |
| Leveling agent T-1 | 0.08 parts by mass |
| Chiral agent Ch-1 | 5.45 parts by mass |
| Methyl ethyl ketone: | 300.00 parts by mass |

-Chiral agent Ch-1-

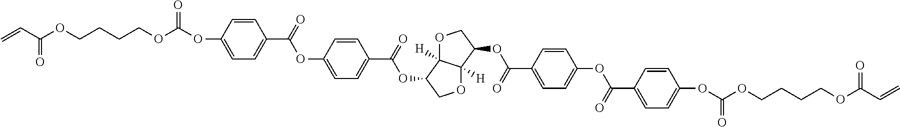 [SMILES: C=CC(=O)OCCCCOC(=O)Oc1ccc(C(=O)Oc2ccc(C(=O)O[C@H]3CO[C@H]4[C@@H]3OC[C@H]4OC(=O)c3ccc(OC(=O)c4ccc(OC(=O)OCCCCOC(=O)C=C)cc4)cc3)cc2)cc1]

<Coating Formation of Optically Anisotropic Layer c-1>

The optically anisotropic layer C-1 was formed by applying multiple layers of the liquid crystal composition DC1 to the alignment film P-1.

The coating film obtained by applying the above-described liquid crystal composition DC1 to the alignment film P-1 was heated to 110° C. on a hot plate, cooled to 60° C., and irradiated with ultraviolet light having a wavelength of 365 nm at an irradiation dose of 300 mJ/cm² using a high-pressure mercury lamp in a nitrogen atmosphere, thereby immobilizing the alignment of the liquid crystal compound. The film thickness of the immobilized liquid crystal layer (one liquid crystal immobilized layer) at this time was 2.3 μm.

The second and subsequent liquid crystal immobilization layers were formed by coating the previously formed liquid crystal immobilization layer with the liquid crystal composition DC1 through overcoating, heating and cooling the composition under the same conditions as described above, and then curing the composition using ultraviolet rays. In this manner, the overcoating was repeated until the total thickness reached a desired film thickness (here, 4.6 μm), thereby obtaining the optically anisotropic layer C-1. Further, it was confirmed that the surface was periodically aligned using a polarizing microscope and an SEM.

### Comparative Example 12

An alignment film was formed on the support in the same manner as in Comparative Example 1. An optically anisotropic layer C-2 (disk-like liquid crystal layer) consisting of a cured layer of a liquid crystal composition EC1 including a disk-like liquid crystal compound was formed on the alignment film to produce an optical element of Comparative Example 12. In the optically anisotropic layer C-2, the disk-like liquid crystal compound was horizontally rotationally aligned, and the liquid crystal alignment pattern had a cholesteric phase in the thickness direction.

### [Preparation of Optical Element of Comparative Example 12]

An optical element of Comparative Example 12 was prepared in the same manner as in Comparative Example 2 except that an optically anisotropic layer having a liquid crystal alignment pattern with a cholesteric phase was formed using the liquid crystal composition E1 as the liquid crystal composition EC1. From a cross-sectional SEM of the optical element, it was confirmed that the liquid crystal alignment pattern had a cholesteric phase.

### (Formation of Optically Anisotropic Layer C-2)

A liquid crystal composition EC1 with the following composition was prepared.

### <Liquid Crystal Composition EC1>

| | |
|---|---|
| Disk-like liquid crystal compound L-2 | 80.00 parts by mass |
| Disk-like liquid crystal compound L-3 | 20.00 parts by mass |
| Polymerization initiator (Irgacure | 5.00 parts by mass |
| (registered trade name) 907, manufactured | |
| by BASF SE) | |
| Chiral agent Ch-2 | 3.79 parts by mass |
| MEGAFACE F444 (manufactured by | 0.50 parts by mass |
| DIC Corporation) | |
| Methyl ethyl ketone: | 300.00 parts by mass |

-Chiral agent Ch-2-

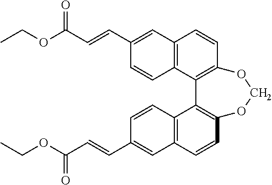

### <Coating Formation of Optically Anisotropic Layer C-2>

In Comparative Example 11, an optically anisotropic layer was formed by applying multiple layers of the liquid crystal composition EC1 to the alignment film P-1 instead of the liquid crystal composition DC1.

First, as the first layer, the coating film obtained by coating the alignment film P-1 with the following liquid crystal composition EC1 was heated on a hot plate at 95° C. and then cooled to 25° C., and the coating film was irradiated with ultraviolet rays having a wavelength of 365 nm at an irradiation dose of 300 mJ/cm² using a high pressure mercury lamp in a nitrogen atmosphere, thereby immobilizing the alignment of the liquid crystal compound. The film thickness of the immobilized liquid crystal layer (one liquid crystal immobilized layer) at this time was 2.3 μm.

The second and subsequent liquid crystal immobilization layers were formed by coating the previously formed liquid crystal immobilization layer with the liquid crystal composition EC1 through overcoating, heating and cooling the composition under the same conditions as described above, and then curing the composition using ultraviolet rays. In this manner, the overcoating was repeated until the total thickness reached a desired film thickness (here, 4.6 μm), thereby obtaining an optically anisotropic layer C-2. Further, it was confirmed that the surface was periodically aligned using a polarizing microscope and an SEM.

### Example 11

An alignment film was formed on a support, an optically anisotropic layer C-3 (rod-like liquid crystal layer) consisting of a cured layer of the liquid crystal composition DC1 including a rod-like liquid crystal compound was formed on the alignment film, and an optically anisotropic layer C-4 (disk-like liquid crystal layer) consisting of a cured layer of the liquid crystal composition EC1 including a disk-like liquid crystal compound was formed to manufacture an optical element of Example 11. Hereinafter, the optically anisotropic layer C-3 (rod-like liquid crystal layer) in the present example will be referred to as “first optically anisotropic layer C-3”, and the optically anisotropic layer C-4 (disk-like liquid crystal layer) will be referred to as “second optically anisotropic layer C-4”.

That is, the optical element had a two-layer structure of the first optically anisotropic layer C-3 formed of a cured layer of a liquid crystal composition containing a rod-like liquid crystal compound as the first layer and the second optically anisotropic layer C-4 formed of a cured layer of a liquid crystal composition containing a disk-like liquid crystal compound as the second layer.

In the optical element of Example 11, an alignment film was formed on a support in the same manner as in Comparative Example 11, a first optically anisotropic layer C-3 was formed on the alignment film, and a second optically anisotropic layer C-4 was formed on the first optically anisotropic layer C-3 in the same manner as the optically anisotropic layer C-2 formed on the alignment film in Comparative Example 12. In this case, the film thicknesses of the optically anisotropic layers C-3 and C-4 were each set to 2.3 μm such that the total film thickness was the same as the film thickness of the optically anisotropic layer in Comparative Example 12, the coating amount was adjusted such that the total film thickness of the two layers was 4.6 μm, and the optical element was manufactured in the same manner as in Comparative Example 11 and Comparative Example 12. The optical element of Example 11 was formed by forming a continuous single cholesteric alignment in two layers of the first optically anisotropic layer C-3 and the second optically anisotropic layer C-4 in the thickness direction. Further, it was confirmed that the surface was periodically aligned using a polarizing microscope and an SEM.

### [Evaluation]

The intensity of diffracted light diffracted by the optical element manufactured in each example was measured by the following method to measure the diffraction efficiency of each optical element.

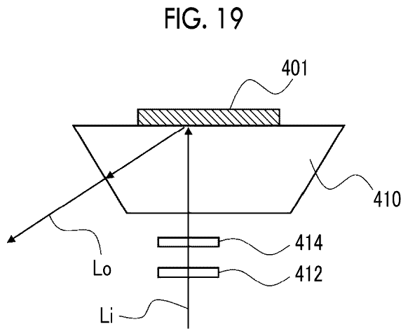

As shown in FIG. 19, the manufactured optical element 401 was disposed on a surface (upper surface in the drawing) of a dove prism 410. As the dove prism 410, a dove prism formed of glass having a refractive index of 1.5 was used. The optical element 401 was bonded to the dove prism 410 using a thermosensitive adhesive by peeling off the support (glass substrate).

As shown in FIG. 19, a laser light source (not shown) was disposed at a position facing the lower surface of the dove prism 410 facing the surface on which the optical element 401 was disposed. Further, a linear polarizer 412 and a λ/4 plate 414 were disposed between the laser light source and the dove prism 410.

Laser light Li emitted from the laser light source was incident into the dove prism 410 as circularly polarized light by passing through the linear polarizer 412 and the λ/4 plate 414.

The laser light Li incident into the dove prism 410 propagated in the dove prism 410 and was incident into the optical element 401 disposed at a position facing the incident surface (lower surface). As described above, the optical element 401 had the optically anisotropic layer (cholesteric liquid crystal layer) having a cholesteric alignment. The laser light Li incident into the optical element 401 was reflected and diffracted by the optical element 401 (cholesteric liquid crystal layer) as described above, propagated in the dove prism 410, and was emitted from the dove prism 410.

The wavelength of the laser light Li was 532 nm. In addition, the angle of the laser light source was adjusted such that the laser light Li was incident at 0° with respect to the normal direction of the main surface of the optical element 401. That is, the laser light Li was incident into the optical element 401 from the normal direction of the main surface of the optical element 400.

The laser light Li was incident into the optical element 401, and the intensity of emitted light Lo emitted from the dove prism 410 by being reflected and diffracted in a desired direction (a direction of an oblique surface of the dove prism 410) oblique to the normal direction of the main surface of the optical element 401 by the optical element 401 was measured.

In a case where the intensity of the laser light Li incident into the dove prism 410 was denoted by Iᵢₙ and the intensity of diffracted light (first-order light) diffracted in the desired direction, that is, the intensity of the emitted light Lo emitted from the dove prism 410 by being diffracted by the optical element 401 was denoted by Iₒᵤₜ, the diffraction efficiency Deff of the manufactured optical element 401 was calculated by the following expression.

Diffraction efficiency Deff=Iₒᵤₜ/Iᵢₙ

The diffraction efficiency was calculated by excluding the loss of transmittance at the interface during incidence into the dove prism 410 and emission from the dove prism 410.

In the optical element manufactured in Example 11, a high diffraction efficiency was obtained at a wavelength of 532 nm as compared with Comparative Examples 11 and 12.

From the above results, the effect of Examples of the present embodiment of the present invention is clear.

The present invention can be suitably used for various optical devices and optical systems such as HMDs such as AR glasses and VR goggles.

### EXPLANATION OF REFERENCES

10, 10b, 10c, 100, 100IR, 100IG, 100IB, 100OR, 1000G, 1000B, 128, 142: optical element
30: support
32: alignment film
37b: first laminate
37c: second laminate
40c: rod-like liquid crystal compound
40d: disk-like liquid crystal compound
40A: optical axis
42, 42b, 46, 102: rod-like liquid crystal layer
44, 44b, 104: disk-like liquid crystal layer
60: exposure device
62: laser
64: light source
65: λ/2 plate
68, 86, 94: polarization beam splitter
70A, 70B, 90A, 90B: mirror
72A, 72B, 96: λ/4 plate
92: lens
110: AR glasses
112: light guide plate
114: incidence unit
116: emission unit
120, 140: VR goggles
124: image display element
126: circular polarizer
130: half mirror
144: lens
146: reflective circular polarizer
400, 401: optical element
410: dove prism
412: linear polarizer
414: λ/4 plate
Li: laser beam
Lo: emitted light
D: arrangement axis
R: region
Λ: single period
M: laser beam
MA, MB: rays
P_{O}: linearly polarized light
P_{R}: dextrorotatory circularly polarized light
P_{L}: levorotatory circularly polarized light
α: angle
L₁, L₄: incident light
L₂, L₅: emitted light

What is claimed is:

1. An optical element comprising:
a first optically anisotropic layer that is a cured layer of a liquid crystal composition containing a rod-like liquid crystal compound; and
a second optically anisotropic layer that is a cured layer of a liquid crystal composition containing a disk-like liquid crystal compound,
wherein the first optically anisotropic layer has a first liquid crystal alignment pattern in which the rod-like liquid crystal compound is arranged along at least one in-plane direction and in which a direction of an optical axis derived from the rod-like liquid crystal compound changes while continuously rotating, and has, in the first liquid crystal alignment pattern, a region in which the direction of the optical axis of the rod-like liquid crystal compound rotates by 180° with a period shorter than 0.5 μm, and
the second optically anisotropic layer has a second liquid crystal alignment pattern in which the disk-like liquid crystal compound is arranged along at least one in-plane direction and in which a direction of an optical axis derived from the disk-like liquid crystal compound changes while continuously rotating, and has, in the second liquid crystal alignment pattern, a region in which the direction of the optical axis of the disk-like liquid crystal compound rotates by 180° with a period shorter than 0.5 μm.

2. The optical element according to claim 1,
wherein in the first optically anisotropic layer, the rod-like liquid crystal compound is twisted and aligned in a thickness direction of the first optically anisotropic layer according to a first twist property.

3. The optical element according to claim 1,
wherein in the second optically anisotropic layer, the disk-like liquid crystal compound is twisted and aligned in a thickness direction of the second optically anisotropic layer according to a second twist property.

4. The optical element according to claim 2,
wherein in the second optically anisotropic layer, the disk-like liquid crystal compound is twisted and aligned in a thickness direction of the second optically anisotropic layer according to a second twist property,
the first twist property and the second twist property are the same in direction, and
in the first optically anisotropic layer and the second optically anisotropic layer, twisted alignment of the optical axis of the rod-like liquid crystal compound and twisted alignment of the optical axis of the disk-like liquid crystal compound form continuous twisted alignment.

5. The optical element according to claim 2,
wherein in the second optically anisotropic layer, the disk-like liquid crystal compound is twisted and aligned in a thickness direction of the second optically anisotropic layer according to a second twist property, and
the first twist property and the second twist property are opposite in direction.

6. The optical element according to claim 1,
wherein in the first optically anisotropic layer, the rod-like liquid crystal compound is cholesterically aligned in a thickness direction, and
in the second optically anisotropic layer, the disk-like liquid crystal compound is cholesterically aligned in a thickness direction.

7. The optical element according to claim 6,
wherein the rod-like liquid crystal compound in the first optically anisotropic layer and the disk-like liquid crystal compound in the second optically anisotropic layer are continuously cholesterically aligned in a thickness direction.

8. The optical element according to claim 1,
wherein the first optically anisotropic layer has a region in which the rod-like liquid crystal compound is tilt-aligned in a plane of the optically anisotropic layer in a thickness direction of the first optically anisotropic layer.

9. The optical element according to claim 1,
wherein the second optically anisotropic layer has a region in which the disk-like liquid crystal compound is tilt-aligned in a plane of the optically anisotropic layer in a thickness direction of the second optically anisotropic layer.

10. The optical element according to claim 1,
wherein an optically anisotropic layer that is the cured layer of the liquid crystal composition containing the rod-like liquid crystal compound and an optically anisotropic layer that is the cured layer of the liquid crystal composition containing the disk-like liquid crystal compound are alternately laminated.

11. The optical element according to claim 1,
wherein the optical element is a transmission-type optical element, and
the optical element has:
a combination of the first optically anisotropic layer and the second optically anisotropic layer that are twisted clockwise and aligned in a thickness direction of the optical element; and
a combination of the first optically anisotropic layer and the second optically anisotropic layer that are twisted counterclockwise and aligned in the thickness direction of the optical element.

12. The optical element according to claim 1,
wherein the optical element is a reflective optical element,
the optical element has:
a combination of the first optically anisotropic layer and the second optically anisotropic layer that selectively reflect right circularly polarized light; and
a combination of the first optically anisotropic layer and the second optically anisotropic layer that selectively reflect left circularly polarized light, and
the combination selectively reflecting right circularly polarized light and the combination selectively reflecting left circularly polarized light selectively reflect light of a same color.

13. A head-mounted display comprising:
the optical element according to claim 1.

14. The optical element according to claim 2,
wherein in the second optically anisotropic layer, the disk-like liquid crystal compound is twisted and aligned in a thickness direction of the second optically anisotropic layer according to a second twist property.

15. The optical element according to claim 2,
wherein the first optically anisotropic layer has a region in which the rod-like liquid crystal compound is tilt-aligned in a plane of the optically anisotropic layer in a thickness direction of the first optically anisotropic layer.

16. The optical element according to claim 2,
wherein the second optically anisotropic layer has a region in which the disk-like liquid crystal compound is tilt-aligned in a plane of the optically anisotropic layer in a thickness direction of the second optically anisotropic layer.

17. The optical element according to claim 2,
wherein an optically anisotropic layer that is the cured layer of the liquid crystal composition containing the rod-like liquid crystal compound and an optically anisotropic layer that is the cured layer of the liquid crystal composition containing the disk-like liquid crystal compound are alternately laminated.

18. A head-mounted display comprising:
the optical element according to claim 2.

19. The optical element according to claim 3,
wherein the first optically anisotropic layer has a region in which the rod-like liquid crystal compound is tilt-aligned in a plane of the optically anisotropic layer in a thickness direction of the first optically anisotropic layer.

20. The optical element according to claim 3,
wherein the second optically anisotropic layer has a region in which the disk-like liquid crystal compound is tilt-aligned in a plane of the optically anisotropic layer in a thickness direction of the second optically anisotropic layer.
